(19) United States
(12) Patent Application Publication
(10) Pub. No.: US 2025/0260209 A1
(43) Pub. Date: Aug. 14, 2025

(54) OPTICAL AMPLIFICATION APPARATUS, OPTICAL TRANSMISSION SYSTEM, AND OPTICAL AMPLIFICATION METHOD

(71) Applicant: NEC Corporation, Tokyo (JP)

(72) Inventor: Yusuke SHIMOMURA, Tokyo (JP)

(73) Assignee: NEC Corporation, Tokyo (JP)

(21) Appl. No.: 19/019,924

(22) Filed: Jan. 14, 2025

(30) Foreign Application Priority Data
Feb. 9, 2024 (JP) 2024-018597

(51) Int. Cl. H01S 3/067; H01S 3/10; H04B 10/25; H04B 10/297

(52) U.S. Cl. CPC H01S 3/06716; H01S 3/10023; H04B 10/2589; H04B 10/297

(57) ABSTRACT

An optical amplification apparatus, an optical transmission system, and an optical amplification method that make it possible to suppress deterioration in signal light quality are provided. An optical amplification apparatus is an optical amplification apparatus connected between a first multi-core fiber and a second multi-core fiber, and includes: a switch configured to switch a transmission direction of signal light being unidirectionally transmitted in the first multi-core fiber and the second multi-core fiber, into bidirectional transmission; and an amplifier configured to amplify the signal light being bidirectionally transmitted.

### INCORPORATION BY REFERENCE

This application is based upon and claims the benefit of priority from Japanese patent application No. 2024-018597, filed on Feb. 9, 2024, the disclosure of which is incorporated herein in its entirety by reference.

### TECHNICAL FIELD

The present disclosure relates to an optical amplification apparatus, an optical transmission system, and an optical amplification method.

### BACKGROUND ART

In recent years, in order to expand transmission capacity in optical communication, a multi-core fiber in which a plurality of cores are formed in one optical fiber has been used. For example, Patent Literature 1 describes an optical amplification apparatus using a multi-core erbium-doped fiber (MC-EDF). Further, Non Patent Literature 1 describes a multi-core fiber capable of reducing inter-core crosstalk.

### CITATION LIST

### Patent Literature

Patent Literature 1: Japanese Unexamined Patent Application Publication No. 2021-145255

### Non Patent Literature

Non Patent Literature 1: Masanori Takahashi et al., “Uncoupled 4-core Fibre with Ultra-low Loss and Low Inter Core Crosstalk”, 2020 European Conference on Optical Communications (ECOC), IEEE, December 2020

### SUMMARY

For example, in related techniques such as Patent Literature 1 and Non Patent Literature 1, since influence of inter-core crosstalk caused in an optical amplification apparatus using an MC-EDF or the like is not taken into consideration, signal light quality may deteriorate.

An example object of the present disclosure is to provide an optical amplification apparatus, an optical transmission system, and an optical amplification method that make it possible to suppress deterioration in signal light quality.

In a first example aspect, an optical amplification apparatus is an optical amplification apparatus connected between a first multi-core fiber and a second multi-core fiber, and includes: a switching unit configured to switch a transmission direction of signal light being unidirectionally transmitted in the first multi-core fiber and the second multi-core fiber, into bidirectional transmission; and an amplification unit configured to amplify the signal light being bidirectionally transmitted.

In a second example aspect, an optical transmission system includes: a first multi-core fiber; a second multi-core fiber; and an optical amplification apparatus connected between the first multi-core fiber and the second multi-core fiber, wherein the optical amplification apparatus includes a switching unit configured to switch a transmission direction of signal light being unidirectionally transmitted in the first multi-core fiber and the second multi-core fiber, into bidirectional transmission, and an amplification unit configured to amplify the signal light being bidirectionally transmitted.

In a third example aspect, an optical amplification method is an optical amplification method for an optical amplification apparatus connected between a first multi-core fiber and a second multi-core fiber, and includes: switching a transmission direction of signal light being unidirectionally transmitted in the first multi-core fiber and the second multi-core fiber, into bidirectional transmission; and amplifying the signal light being bidirectionally transmitted.

According to the present disclosure, it is possible to suppress deterioration in signal light quality.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram for describing unidirectional transmission in a multi-core fiber;

FIG. 2 is a diagram for describing bidirectional transmission in a multi-core fiber;

FIG. 3 is a configuration diagram illustrating a configuration example of a related optical transmission system;

FIG. 4 is a configuration diagram illustrating a configuration example of a related optical transmission system;

FIG. 5 is a graph illustrating a measurement result of signal quality according to some example embodiments;

FIG. 6 is a configuration diagram illustrating a configuration example of an optical transmission system according to some example embodiments;

FIG. 7 is a configuration diagram illustrating a configuration example of an optical transmission system according to some example embodiments;

FIG. 8 is a diagram for describing a transmission direction switching principle of an optical amplification apparatus according to some example embodiments;

FIG. 9 is a configuration diagram illustrating a configuration example of an optical amplification apparatus according to some example embodiments;

FIG. 10 is a diagram for describing a transmission direction switching principle of an optical amplification apparatus according to some example embodiments;

FIG. 11 is a configuration diagram illustrating a configuration example of an optical amplification apparatus according to some example embodiments;

FIG. 12 is a diagram for describing a transmission direction switching principle of an optical amplification apparatus according to some example embodiments;

FIG. 13 is a configuration diagram illustrating a configuration example of an optical amplification apparatus according to some example embodiments;

FIG. 14 is a diagram for describing a transmission direction switching principle of an optical amplification apparatus according to some example embodiments;

FIG. 15 is a configuration diagram illustrating a configuration example of an optical amplification apparatus according to some example embodiments;

FIG. 16 is a diagram for describing a transmission direction switching principle of an optical amplification apparatus according to some example embodiments;

FIG. 17 is a configuration diagram illustrating a configuration example of an optical amplification apparatus according to some example embodiments;

FIG. 18 is a configuration diagram illustrating a configuration example of an optical amplification apparatus according to some example embodiments;

FIG. 19 is a configuration diagram illustrating a configuration example of an optical amplification apparatus according to some example embodiments; and

FIG. 20 is a configuration diagram illustrating a configuration example of an optical amplification apparatus according to some example embodiments.

### EXAMPLE EMBODIMENT

Hereinafter, example embodiments are described with reference to the drawings. In the drawings, the same element is denoted by the same reference numeral, and redundant descriptions are omitted as necessary.

### (Study of Related Technique)

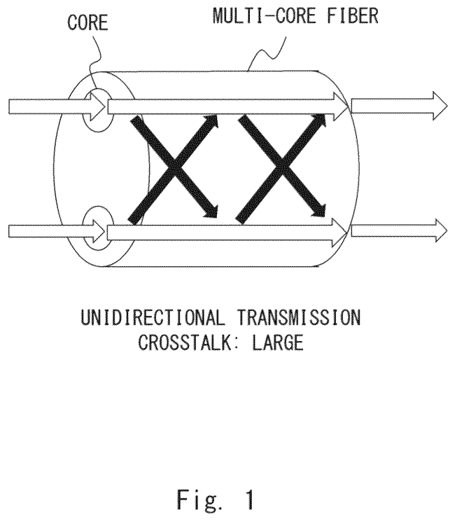

FIG. 1 is a diagram for describing unidirectional transmission in a multi-core fiber. Unidirectional transmission is a transmission scheme in which signal light is transmitted in the same direction through a plurality of cores in a multi-core fiber. In the example of FIG. 1, two cores transmit signal light in the same direction. In the case of unidirectional transmission, for example, signal light transmitted through two cores interfere with each other, thereby causing crosstalk (inter-core crosstalk) to occur and resulting in a problem that transmission quality deteriorates.

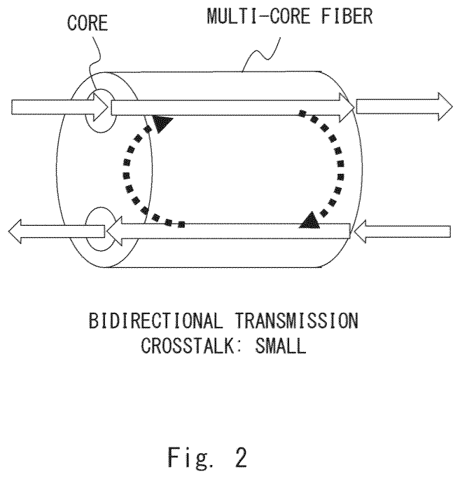

FIG. 2 is a diagram for describing bidirectional transmission in a multi-core fiber. Bidirectional transmission is a transmission scheme in which signal light is transmitted in different transmission directions for each core in a multi-core fiber. In the example of FIG. 2, two cores transmit signal light in opposite directions. In the case of bidirectional transmission, for example, interference of signal light transmitted by two cores can be suppressed, and thus inter-core crosstalk can be reduced.

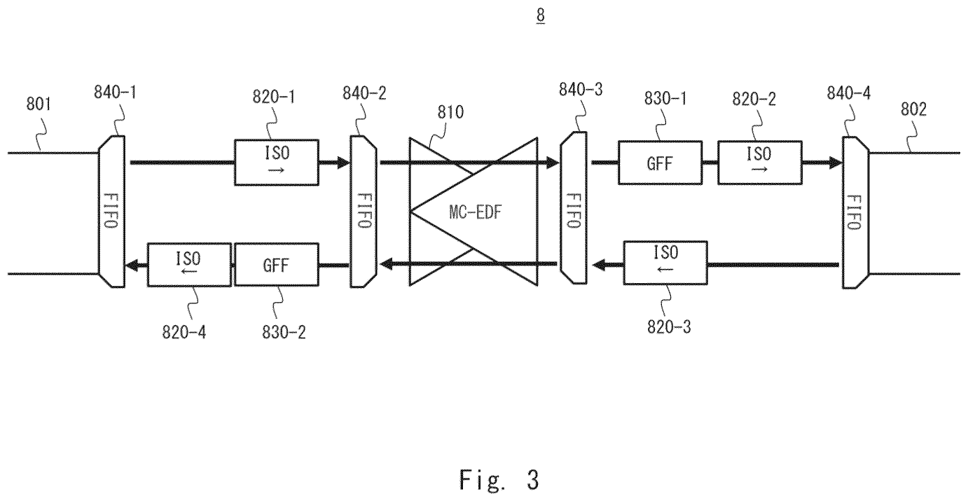

First, the inventors have studied problems in the case of performing bidirectional transmission and in the case of performing unidirectional transmission with a multi-core fiber. FIG. 3 illustrates a configuration example of a related optical transmission system that performs bidirectional transmission. In the example of FIG. 3, an optical transmission system 8 is a system which executes amplification and transmission between multi-core transmission line fibers 801 and 802 by using an MC-EDF 810 being an optical amplifier. As illustrated in FIG. 3, the optical transmission system 8 includes an isolator (ISO) 820, a gain flattening filter (GFF) 830, and a fan-in/fan-out (FIFO) 840.

An ISO is required for inputting and outputting optical signals in one direction for each signal path. In addition, since the power of the light amplified by the MC-EDF 810 varies for each wavelength due to the wavelength dependency, it is necessary to dispose a GFF at a subsequent stage of the MC-EDF 810. Therefore, in the example of FIG. 3, on a path for propagating the signal light from the first core of the transmission line fiber 801 to the first core of the transmission line fiber 802, an ISO 820-1 is disposed in a preceding stage of the MC-EDF 810, and a GFF 830-1 and an ISO 820-2 are disposed in a subsequent stage of the MC-EDF 810. Further, on a path for propagating the signal light from the second core of the transmission line fiber 802 to the second core of the transmission line fiber 801, an ISO 820-3 is disposed in the preceding stage of the MC-EDF 810, and a GFF 830-2 and an ISO 820-4 are disposed in the subsequent stage of the MC-EDF 810.

Further, in order to separate/couple signal light of multiple cores to signal light of a single core, a FIFO 840-1 is disposed between the transmission line fiber 801 and the ISO 820-1 and ISO 820-4, a FIFO 840-2 is disposed between the ISO 820-1 and GFF 830-2 and the MC-EDF 810, a FIFO 840-3 is disposed between the MC-EDF 810 and the GFF 830-1 and ISO 820-3, and a FIFO 840-4 is disposed between the ISO 820-2 and ISO 820-3 and the transmission line fiber 802.

As illustrated in FIG. 3, by performing bidirectional transmission between the transmission line fiber and the MC-EDF, inter-core crosstalk between the transmission line fiber and the MC-EDF can be reduced. However, in order to perform bidirectional transmission, as illustrated in FIG. 3, a FIFO is required in order to effectively dispose a GFF and an ISO for each core. Therefore, there is a problem that a loss due to the FIFO increases and the number of components increases.

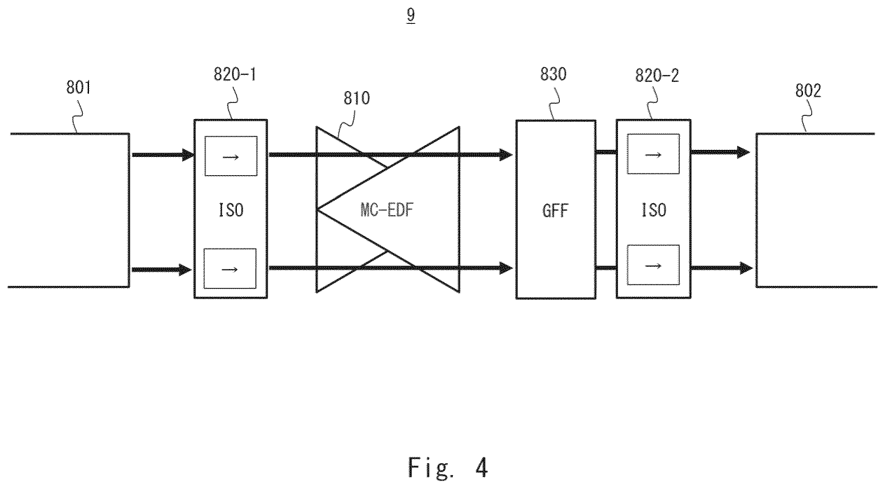

FIG. 4 illustrates a configuration example of a related optical transmission system that performs unidirectional transmission. In a case where performing unidirectional transmission, as illustrated in FIG. 4, an optical transmission system 9 has a configuration composed only of an MC-EDF 810, ISOs 820-1 and 820-2, and a GFF 830. That is, in order to propagate signal light from two cores of a transmission line fiber 801 to two cores of a transmission line fiber 802, the ISO 820-1 is disposed in a preceding stage of the MC-EDF 810, and the GFF 830 and the ISO 820-2 are disposed in a subsequent stage of the MC-EDF 810.

As illustrated in FIG. 4, in unidirectional transmission, since the transmission direction of the signal light of each cores are the same, ISO and GFF for each core can be integrated. Therefore, in unidirectional transmission, since a FIFO such as bidirectional transmission is unnecessary, it is possible to suppress the occurrence of loss due to the FIFO, and it is possible to reduce the number of components. However, in the case of performing unidirectional transmission, there is a problem that inter-core crosstalk occurs between the transmission line fiber and the MC-EDF as illustrated in FIG. 1.

Therefore, according to the example embodiments, it is possible to suppress the occurrence of loss due to optical components while suppressing inter-core crosstalk.

### First Example Embodiment

Next, a first example embodiment is described. In the present example embodiment, a basic example of an optical transmission system including an optical amplification apparatus is described.

With regard to a transmission line fiber in an optical transmission system, in recent years, due to the advancement of fiber technology, it has become possible to suppress inter-core crosstalk even in unidirectional transmission. For example, as disclosed in Non Patent Literature 1, a multi-core fiber in which crosstalk is suppressed to less than −60 dB/km in unidirectional transmission has already been developed.

Meanwhile, in an MC-EDF, suppressing crosstalk in unidirectional transmission has not been advanced. Therefore, by using the related technique, inter-core crosstalk can be suppressed in the transmission line fiber, but inter-core crosstalk cannot be suppressed in the MC-EDF.

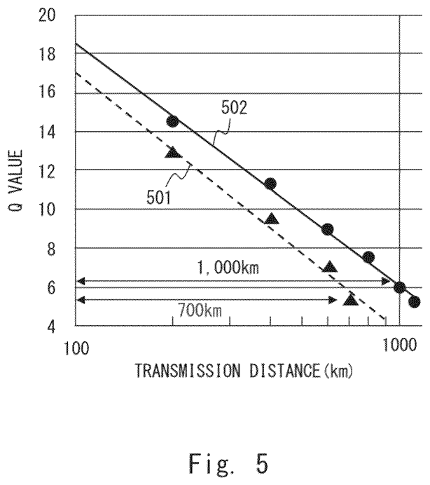

In order to study a method of suppressing inter-core crosstalk in an MC-EDF, the inventors measured signal quality in the case of performing unidirectional transmission and in the case of performing bidirectional transmission in the MC-EDF. FIG. 5 illustrates a measurement result of the experiment acquired by the inventor, regarding signal quality (Q value) according to the transmission distance in the optical transmission system. That is, FIG. 5 illustrates the difference in transmittable distance according to the transmission direction of the MC-EDF. I In FIG. 5, reference numeral 501 denotes the signal quality in a case where unidirectional transmission is performed in the transmission line fiber and unidirectional transmission is performed in the MC-EDF, and reference numeral 502 denotes the signal quality in a case where unidirectional transmission is performed in the transmission line fiber and bidirectional transmission is performed in the MC-EDF.

From the experimental results of FIG. 5, it is found that the inter-core crosstalk in the case where the unidirectional transmission is performed in the MC-EDF is relatively large, and the transmission distance is increased by 1.4 times by performing bidirectional transmission in the MC-EDF (for example, 700 km in unidirectional transmission and 1000 km in bidirectional transmission). Therefore, bidirectional transmission is effective as a method for reducing inter-core crosstalk of the MC-EDF. Therefore, in the example embodiment, the inter-core crosstalk can be reduced by performing bidirectional transmission in the MC-EDF.

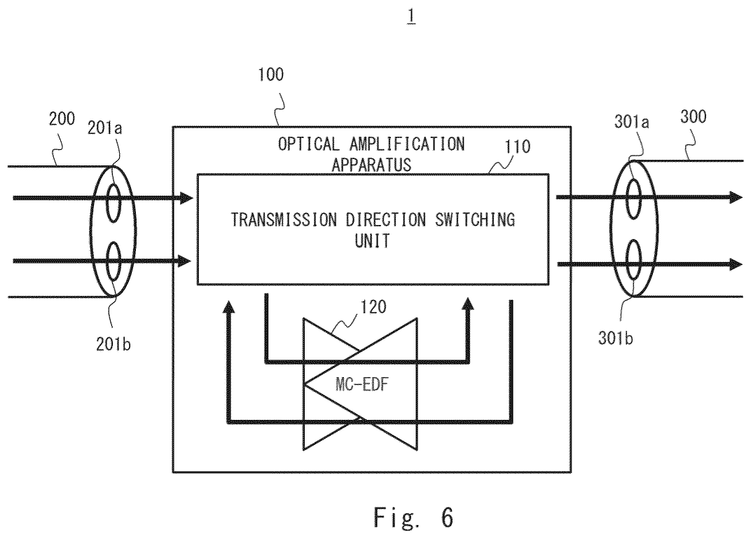

FIG. 6 illustrates a configuration example of an optical transmission system 1 according to some example embodiments. In the example of FIG. 6, the optical transmission system 1 includes an optical amplification apparatus 100 between a transmission line fiber 200 and a transmission line fiber 300.

The transmission line fiber 200 (e.g., first multi-core fiber) and the transmission line fiber 300 (e.g., second multi-core fiber) are multi-core fibers. Each of the transmission line fiber 200 and the transmission line fiber 300 may include two cores, or may include more cores.

The transmission line fiber 200 is an optical fiber that transmits signal light to be input to the optical amplification apparatus 100 on the input side of the optical amplification apparatus 100. The transmission line fiber 200 includes a core 201a (e.g., one of first and second input-side cores) and a core 201b (e.g., the other of the first and second input-side cores).

The transmission line fiber 300 is an optical fiber that transmits signal light output from the optical amplification apparatus 100 on the output side of the optical amplification apparatus 100. The transmission line fiber 300 includes a core 301a (e.g., one of first and second output-side cores) and a core 301b (e.g., the other of the first and second output-side cores).

In the example of FIG. 6, unidirectional transmission is performed in the transmission line fiber 200 and the transmission line fiber 300. For example, by using a multi-core fiber capable of suppressing crosstalk as described in Non Patent Literature 1 as the transmission line fiber 200 and the transmission line fiber 300, inter-core crosstalk in the transmission line fiber 200 and the transmission line fiber 300 can be reduced. Note that other multi-core fibers may be used as the transmission line fiber 200 and the transmission line fiber 300.

The optical amplification apparatus 100 is an amplification apparatus configured to amplify light by using an MC-EDF. The optical amplification apparatus 100 is connected between the transmission line fiber 200 and the transmission line fiber 300. The optical amplification apparatus 100 amplifies two beams of signal light output from the cores 201a and 201b of the transmission line fiber 200, and outputs the amplified two beams of signal light to the cores 301a and 301b of the transmission line fiber 300.

The optical amplification apparatus 100 includes a transmission direction switching unit 110 and an MC-EDF 120. In the optical amplification apparatus 100, bidirectional transmission is performed in the MC-EDF 120. Thereby, inter-core crosstalk in the MC-EDF 120 is reduced.

The transmission direction switching unit 110 is a switching unit configured to switch the transmission direction between the transmission line fibers 200 and 300 and the MC-EDF 120. In order to perform bidirectional transmission in the MC-EDF 120, the transmission direction switching unit 110 switches the transmission direction of signal light, being unidirectionally transmitted in the transmission line fibers 200 and 300, into bidirectional transmission. For example, the transmission direction switching unit 110 bidirectionally (reversely) inputs two beams of signal light, output in the same direction from the cores 201a and 201b of the transmission line fiber 200, to the MC-EDF 120. The transmission direction switching unit 110 unidirectionally outputs the two beams of signal light, amplified by the MC-EDF 120 and bidirectionally output, to the cores 301a and 301b of the transmission line fiber 300.

The MC-EDF 120 is an amplification unit configured to amplify signal light being input. Excitation light is input to the MC-EDF 120 together with signal light, then the signal light is excited and amplified. The excitation method thereof may be core excitation for inputting excitation light to a core or cladding excitation for inputting excitation light to a cladding. The MC-EDF 120 is a multi-core optical amplification fiber, and, similarly to the transmission line fibers 200 and 300, may include two cores, or may include more cores.

For example, the MC-EDF 120 includes two cores (a first amplification core and a second amplification core), and amplifies the signal light bidirectionally input from the transmission direction switching unit 110, and outputs the amplified bidirectional signal light to the transmission direction switching unit 110.

For example, the transmission direction switching unit 110 may input the signal light output from the first input-side core (one of the cores 201a and 201b) of the transmission line fiber 200 to the first amplification core on the first end face of the MC-EDF 120, and input the signal light output from the first amplification core on the second end face of the MC-EDF 120 to the first output-side core (one of the cores 301a and 301b) of the transmission line fiber 300. The transmission direction switching unit 110 may input the signal light output from the second input-side core (the other of the cores 201a and 201b) of the transmission line fiber 200 to the second amplification core in the second end face of the MC-EDF 120, and may input the signal light output from the second amplification core in the first end face of the MC-EDF 120 to the second output-side core (the other of the cores 301a and 301b) of the transmission line fiber 300. The configuration of the transmission direction switching unit 110 is not limited to the above as long as such an input-output relationship can be achieved. For example, as in the examples described below, the transmission direction switching unit 110 may be configured to switch the transmission direction by using a mirror.

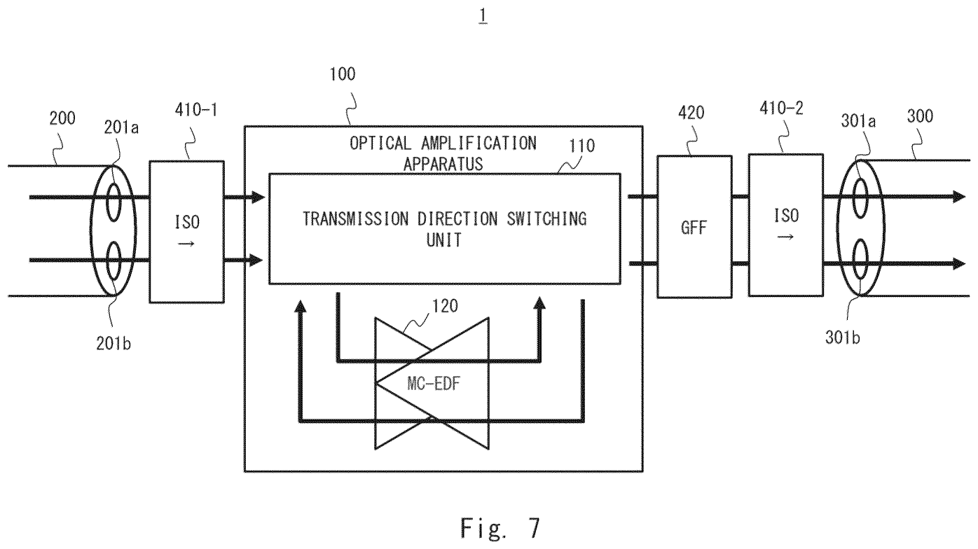

Although an ISO, a GFF, and the like are omitted in the example of FIG. 6, the optical transmission system 1 may include an ISO, a GFF, and the like as necessary. FIG. 7 illustrates a configuration example of the optical transmission system 1 according to some example embodiments. In the example of FIG. 7, similarly to FIG. 4, the optical transmission system 1 includes an ISO 410-1, a GFF 420, and an ISO 410-2.

The ISO 410-1 is disposed between the transmission line fiber 200 and the optical amplification apparatus 100. The ISO 410-1 passes multi-core signal light output from the transmission line fiber 200 to the optical amplification apparatus 100. For example, the ISO 410-1 may be configured by integrating a plurality of isolators that each pass signal light of each core.

The GFF 420 is disposed between the optical amplification apparatus 100 and the ISO 410-2. The GFF 420 flattens the wavelength dependency of the multi-core signal light amplified by the MC-EDF 120. For example, the GFF 420 may be configured by integrating a plurality of filters each for the signal light of each core.

The ISO 410-2 is disposed between the GFF 420 and the transmission line fiber 300. The ISO 410-2 passes the multi-core signal light flattened by the GFF 420 to the transmission line fiber 300. For example, the ISO 410-2 may be configured by integrating a plurality of isolators that each pass signal light of each core.

As described above, in the present example embodiment, the optical transmission system includes the optical amplification apparatus having the transmission direction switching function. Specifically, unidirectional transmission is performed in the transmission line fiber, and transmission is switched to bidirectional transmission in an optical amplification apparatus (MC-EDF) having a large inter-core crosstalk. Thus, by performing bidirectional transmission in the optical amplification apparatus, it is possible to reduce the occurrence of inter-core crosstalk in the optical amplification apparatus. Further, by performing unidirectional transmission in the transmission line fiber, it is possible to reduce the number of optical components such as a FIFO, a GFF, and an isolator, and reduce loss due to the optical components.

### Second Example Embodiment

Next, a second example embodiment is described. In the present example embodiment, an example in which a two-core MC-EDF is used is described as a specific example of the optical amplification apparatus described in the first example embodiment.

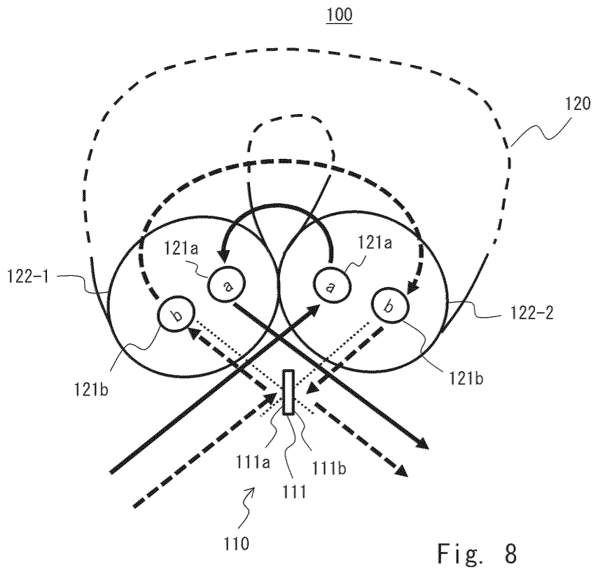

A transmission direction switching principle of an optical amplification apparatus 100 according to some example embodiments is described with reference to FIG. 8. FIG. 8 is a front view of end faces 122-1 and 122-2 of an MC-EDF 120.

In the example of FIG. 8, the MC-EDF 120 is a two-core MC-EDF. That is, the MC-EDF 120 includes cores 121a and 121b. Signal light is bidirectionally input and output to and from the cores 121a and 121b at the end faces 122-1 and 122-2 at both ends of the MC-EDF 120.

As illustrated in FIG. 8, a transmission direction switching unit 110 includes a double-sided mirror 111. The double-sided mirror 111 (reflection unit) switches the direction of signal light by reflecting the signal light being input and output to or from either of the core 121a and the core 121b. For example, the double-sided mirror 111 switches the direction of the signal light being input and output to and from the core 121b. One side 111a (e.g., the first reflection unit) of the double-sided mirror 111 switches the direction of the signal light being input to the core 121b. One side 111b (e.g., the second reflection unit) of the double-sided mirror 111 switches the direction of the signal light being output from the core 121b. The one side 111a and the one side 111b of the double-sided mirror 111 are mirrors that totally reflect light. The transmission direction switching unit 110 is not limited to include the double-sided mirror 111, and may be provided with a first single-sided mirror having the same configuration as the one side 111b and a second single-sided mirror having the same configuration as the one side 111b.

The transmission direction switching function of the transmission direction switching unit 110 is implemented by a positional relationship (including an angle) between a core (e.g., the core 121b) in which the transmission direction change in the end faces 122-1 and 122-2 of the MC-EDF 120 and the double-sided mirror 111. That is, the end faces 122-1 and 122-2 of the MC-EDF 120 and the double-sided mirror 111 are fixed in such a way that the core that changes the transmission direction in the end faces 122-1 and 122-2 of the MC-EDF 120 and the double-sided mirror 111 have a predetermined positional relationship. The transmission direction switching unit 110 may include a fixing unit (not illustrated) that fixes the end faces 122-1 and 122-2 of the MC-EDF 120 and the double-sided mirror 111 in such a way that the core that changes the transmission direction in the end faces 122-1 and 122-2 of the MC-EDF 120 and the double-sided mirror 111 have a predetermined positional relationship.

In the example of FIG. 8, the end face 122-1 and the end face 122-2 of the MC-EDF 120 face each other at a predetermined angle in a state where the MC-EDF 120 is folded back. That is, the MC-EDF 120 is folded back without being twisted. The end face 122-1 and the end face 122-2 face each other without rotating. For example, the core 121a at the end face 122-1 and the core 121a at the end face 122-2 are located on the inner side of where the end face 122-1 and the end face 122-2 face each other. If the end face 122-1 and the end face 122-2 are faced with each other, it can also be said that the core 121a at the end face 122-1 and the core 121a at the end face 122-2 oppose each other. The core 121b at the end face 122-1 and the core 121b at the end face 122-2 are located on the outer side of where the end face 122-1 and the end face 122-2 face each other. If the end face 122-1 and the end face 122-2 are faced with each other, it can also be said that the core 121b at the end face 122-1 and the core 121b at the end face 122-2 oppose each other.

In the example of FIG. 8, it is assumed that the core 121a is a core in which the transmission direction is not switched, and the core 121b is a core in which the transmission direction is switched. Note that, the core 121b may be a core in which the transmission direction is not switched, and the core 121a may be a core in which the transmission direction is switched. That is, one of the two cores is a core in which the transmission direction is not switched, and the other core is a core in which the transmission direction is switched. Thus, inter-core crosstalk in the MC-EDF 120 can be reduced.

As illustrated in FIG. 8, in a case where the end face 122-1 and the end face 122-2 of the MC-EDF 120 face each other at a certain angle, the double-sided mirror 111 is disposed at an intersection of the cores 121b that change the transmission direction in the MC-EDF 120. Specifically, the double-sided mirror 111 is disposed at an intersection of central axis lines (straight lines extending in the optical input/output direction) of the cores 121b that change the transmission direction in the MC-EDF 120. Thus, the transmission direction of the signal light of the core 121b can be switched in the reverse direction with respect to the transmission direction of the signal light of the core 121a.

In a path of the core 121a, the signal light is input to the core 121a at the end face 122-2, and the signal light amplified by the MC-EDF 120 is output from the core 121a at the end face 122-1. In a path of the core 121b, the input signal light is reflected by the one side 111a of the double-sided mirror 111, is input to the core 121b at the end face 122-1, and the signal light amplified by the MC-EDF 120 is output from the core 121b at the end face 122-1. The double-sided mirror 111 is fixed in such a way that the one side 111a is set at an angle to reflect the signal light input from the transmission line fiber 200 to the core 121b at the end face 122-1. The signal light output from the core 121b is reflected by and output from the other one side 111b of the double-sided mirror 111. The double-sided mirror 111 is fixed in such a way that the one side 111b is set at an angle to reflect the signal light output from the core 121b to a transmission line fiber 300. In such a way, by fixing the positional relationship between the core 121b in which the transmission direction changes and the double-sided mirror 111 as illustrated in FIG. 8, the transmission direction in the MC-EDF 120 can be switched to bidirectional transmission.

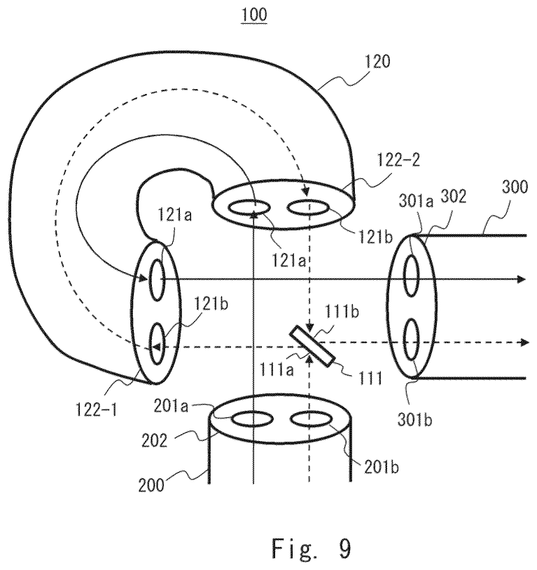

FIG. 9 illustrates a specific configuration example of the optical amplification apparatus 100 described in FIG. 8. FIG. 9 is a top view of the end faces 122-1 and 122-2 of the MC-EDF 120.

As described with reference to FIG. 8, the optical amplification apparatus 100 includes the MC-EDF 120 and the double-sided mirror 111. The optical amplification apparatus 100 may include a fixing unit configured to fix the MC-EDF 120 and the double-sided mirror 111. The end face 122-1 and the end face 122-2 of the MC-EDF 120 and the double-sided mirror 111 are fixed in such a way as to have the positional relationship illustrated in FIG. 8.

In the example of FIG. 9, the end face 122-1 and the end face 122-2 of the MC-EDF 120 are fixed in such a way as to face each other at a right angle. For example, the end face 122-1 and the end face 122-2 are fixed in such a way as to face each other at right angles by folding back the MC-EDF 120 without twisting. The MC-EDF 120 may be circulated to draw out the end face 122-1 and the end face 122-2 as necessary. The MC-EDF 120 may be twisted by 360 degrees×n (n is an integer).

As described with reference to FIG. 8, the core 121a at the end face 122-1 and the core 121a at the end face 122-2 are located on the inner side of where the end face 122-1 and the end face 122-2 face each other. The core 121b at the end face 122-1 and the core 121b at the end face 122-1 are located on the outer side of where the end face 122-1 and the end face 122-2 face each other.

In the example of FIG. 9, the input-side transmission line fiber 200 is disposed in such a way that an end face 202 of the transmission line fiber 200 opposes the end face 122-2 of the MC-EDF 120. Specifically, a core 201a at the end face 202 of the transmission line fiber 200 opposes the core 121a at the end face 122-2 of the MC-EDF 120. It can also be said that the central axis line of the core 201a at the end face 202 of the transmission line fiber 200 overlaps with the central axis line of the core 121a at the end face 122-2 of the MC-EDF 120. A core 201b at the end face 202 of the transmission line fiber 200 opposes the core 121b at the end face 122-2 of the MC-EDF 120 (via the double-sided mirror 111). It can also be said that the central axis line of the core 201b at the end face 202 of the transmission line fiber 200 overlaps with the central axis line of the core 121b at the end face 122-2 of the MC-EDF 120.

The output-side transmission line fiber 300 is fixed in such a way that an end face 302 of the transmission line fiber 300 opposes the end face 122-1 of the MC-EDF 120. Specifically, a core 301a at the end face 302 of the transmission line fiber 300 opposes the core 121a at the end face 122-1 of the MC-EDF 120. It can also be said that the central axis line of the core 301a at the end face 302 of the transmission line fiber 300 overlaps with the central axis line of the core 121a at the end face 122-1 of the MC-EDF 120. Further, a core 301b at the end face 302 of the transmission line fiber 300 opposes the core 121b at the end face 122-1 of the MC-EDF 120 (via the double-sided mirror 111). It can also be said that the central axis line of the core 301b at the end face 302 of the transmission line fiber 300 overlaps with the central axis line of the core 121b at the end face 122-1 of the MC-EDF 120.

As described with reference to FIG. 8, for example, the core 121b of the MC-EDF 120 is a core in which the transmission direction changes. Therefore, the double-sided mirror 111 is disposed at an intersection of the central axis line of the core 121b at the end face 122-2 of the MC-EDF 120 and the central axis line of the core 121b at the end face 122-1 of the MC-EDF 120. It can also be said that the double-sided mirror 111 is disposed at an intersection of a central axis line connecting the core 201b at the end face 202 of the transmission line fiber 200 and the core 121b at the end face 122-2 of the MC-EDF 120, and a central axis line connecting the core 301b at the end face 302 of the transmission line fiber 300 and the core 121b at the end face 122-1 of the MC-EDF 120.

The one side 111a of the double-sided mirror 111 is disposed in such a way as to face the core 201b at the end face 202 of the transmission line fiber 200 and the core 121b at the end face 122-1 of the MC-EDF 120. The one side 111a of the double-sided mirror 111 is fixed at an angle of 45 degrees with respect to the central axis line of the core 201b at the end face 202 of the transmission line fiber 200 and the central axis line of the core 121b at the end face 122-1 of the MC-EDF 120. The one side 111a of the double-sided mirror 111 reflects, at a right angle, light from the core 201b at the end face 202 of the transmission line fiber 200 toward the core 121b at the end face 122-1 of the MC-EDF 120.

The one side 111b of the double-sided mirror 111 is disposed in such a way as to face the core 301b at the end face 302 of the transmission line fiber 300 and the core 121b at the end face 122-2 of the MC-EDF 120. The one side 111b of the double-sided mirror 111 is fixed at an angle of 45 degrees with respect to the central axis line of the core 301b at the end face 302 of the transmission line fiber 300 and the central axis line of the core 121b at the end face 122-2 of the MC-EDF 120. The one side 111b of the double-sided mirror 111 reflects, at a right angle, light from the core 121b at the end face 122-2 of the MC-EDF 120 toward the core 301b at the end face 302 of the transmission line fiber 300.

The signal light output from the core 201a at the end face 202 of the transmission line fiber 200 is input to the core 121a at the end face 122-2 of the MC-EDF 120. The signal light input to the core 121a at the end face 122-2 of the MC-EDF 120 propagates through the MC-EDF 120 and is amplified, and the amplified signal light is output from the core 121a at the end face 122-1 to the core 301a at the end face 302 of the transmission line fiber 300.

The signal light output from the core 201b at the end face 202 of the transmission line fiber 200 is reflected by the one side 111a of the double-sided mirror 111, and is input from the one side 111a to the core 121b at the end face 122-1. The signal light input to the core 121b at the end face 122-1 propagates through the MC-EDF 120 and is amplified, and the amplified signal light is output from the core 121b at the end face 122-1 toward the double-sided mirror 111. The signal light output from the core 121b is reflected by the one side 111b of the double-sided mirror 111, and is output from the one side 111b to the core 301b at the end face 302 of the transmission line fiber 300.

As described above, the function of the transmission direction switching unit in the optical amplification apparatus may be implemented by a mirror that switches the transmission direction. For example, the transmission direction of the MC-EDF can be switched to bidirectional transmission by disposing a mirror and a core for switching the transmission direction in the two-core MC-EDF, in such a way as to have a predetermined positional relationship.

### Modified Example of Second Example Embodiment

In a modified example of the second example embodiment, an example in which 180 degrees of twist is added to the MC-EDF in the optical amplification apparatus described in the second example embodiment is described.

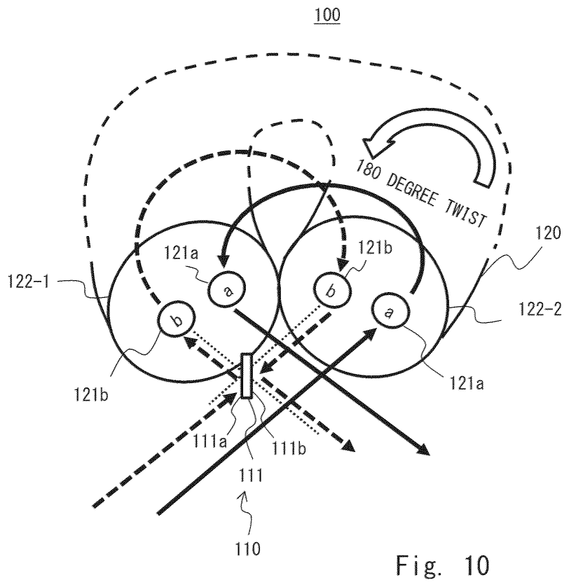

A transmission direction switching principle of the optical amplification apparatus 100 according to some example embodiments is described with reference to FIG. 10. FIG. 10 is a front view of the end faces 122-1 and 122-2 of the MC-EDF 120.

In the example of FIG. 10, the positional relationship between the cores 121a and 121b at the end faces 122-1 and 122-2 of the MC-EDF 120 is different from that in FIG. 8. That is, the MC-EDF 120 is folded back with a 180 degree twist added about the central axis of the fiber. The end face 122-1 and the end face 122-2 of the MC-EDF 120 face each other at a predetermined angle in a state where the MC-EDF 120 is folded back while being twisted by 180 degrees. It can also be said that the end face 122-1 and the end face 122-2 face each other in a state where either one is rotated by 180 degrees. The 180 degrees of twist is an angle at which the core 121 rotates, from a state in which the end face 122 is not rotated (FIG. 8), to the position of an adjacent core 121. For example, the core 121a at the end face 122-1 and the core 121b at the end face 122-2 are located on the inner side of where the end face 122-1 and the end face 122-2 face each other. If the end face 122-1 and the end face 122-2 face each other, it can also be said that the core 121a at the end face 122-1 and the core 121b at the end face 122-2 oppose each other. The core 121b at the end face 122-1 and the core 121a at the end face 122-2 are located on the outer side of where the end face 122-1 and the end face 122-2 face each other. If the end face 122-1 and the end face 122-2 face each other, it can also be said that the core 121b at the end face 122-1 and the core 121a at the end face 122-2 oppose each other.

Similarly to FIG. 8, in a case where the end face 122-1 and the end face 122-2 of the MC-EDF 120 face each other at a certain angle, the double-sided mirror 111 is disposed at an intersection between the cores 121b that change the transmission direction in the MC-EDF 120. In the example of FIG. 10, since the position of the core 121b at the end face 122-2 is different from that of FIG. 8, the position of the double-sided mirror 111 is shifted from that of FIG. 8. That is, the double-sided mirror 111 is disposed at an intersection of the central axis line of the core 121b at the end face 122-2, being on the inner side of where the end face 122-1 and the end face 122-2 face each other, and the central axis line of the core 121b at the end face 122-1, being on the outer side of where the end face 122-1 and the end face 122-2 face each other.

As illustrated in FIG. 10, in the path of the core 121a, signal light is input to the core 121a at the end face 122-2 on the outer side of where the end face 122-1 and the end face 122-2 face each other, and the signal light amplified by the MC-EDF 120 is output from the core 121a at the end face 122-1 on the inner side of where the end face 122-1 and the end face 122-2 face each other. Further, in the path of the core 121b, the input signal light is reflected by the one side 111a of the double-sided mirror 111, the reflected light is input to the core 121b at the end face 122-1 on the outer side of where the end face 122-1 and the end face 122-2 face each other, and the signal light amplified by the MC-EDF 120 is output from the core 121b at the end face 122-1 on the inner side of where the end face 122-1 and the end face 122-2 face each other. The signal light output from the core 121b is reflected by and output from the other one side 111b of the double-sided mirror 111.

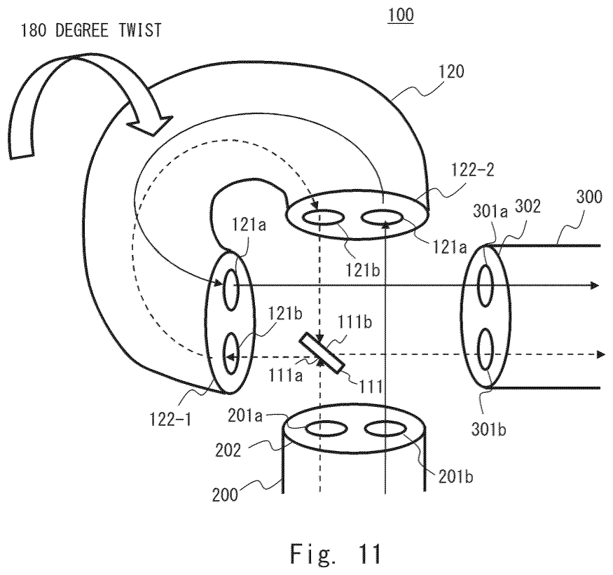

FIG. 11 illustrates a specific configuration example of the optical amplification apparatus 100 described with reference to FIG. 10. FIG. 11 is a top view of the end faces 122-1 and 122-2 of the MC-EDF 120.

In the example of FIG. 11, the positions of the cores 121a and 121b at the end faces 122-1 and 122-2 of the MC-EDF 120 and the double-sided mirror 111 are different from those in FIG. 9.

In the example of FIG. 11, the end face 122-1 and the end face 122-2 of the MC-EDF 120 are fixed in such a way as to face each other at a right angle. For example, the MC-EDF 120 is folded back with a twist of 180 degrees, and the end face 122-1 and the end face 122-2 are fixed in such a way as to face each other at a right angle. The MC-EDF 120 may be circulated to draw out the end face 122-1 and the end face 122-2 as necessary. The MC-EDF 120 may be twisted by 180 degrees+360 degrees×n (n is an integer).

As described with reference to FIG. 10, the core 121a at the end face 122-1 and the core 121b at the end face 122-2 are located on the inner side of where the end face 122-1 and the end face 122-2 face each other. The core 121b at the end face 122-1 and the core 121a at the end face 122-2 are located on the outer side of where the end face 122-1 and the end face 122-2 face each other.

Similarly to FIG. 9, the input-side transmission line fiber 200 is fixed in such a way that the end face 202 of the transmission line fiber 200 faces the end face 122-2 of the MC-EDF 120. The output-side transmission line fiber 300 is fixed in such a way that the end face 302 of the transmission line fiber 300 faces the end face 122-1 of the MC-EDF 120.

As illustrated in FIG. 10, for example, the core 121b of the MC-EDF 120 is a core in which the transmission direction changes. Therefore, the double-sided mirror 111 is disposed at an intersection of the central axis line of the core 121b at the end face 122-2 of the MC-EDF 120, being on the inner side of where the end face 122-1 and the end face 122-2 face each other, and the central axis line of the core 121b at the end face 122-1 of the MC-EDF 120, being on the outer side of where the end face 122-1 and the end face 122-2 face each other. It can also be said that the double-sided mirror 111 is disposed at an intersection of a central axis line connecting the core 201a at the end face 202 of the transmission line fiber 200 and the core 121b at the end face 122-2 of the MC-EDF 120, and a central axis line connecting the core 301b at the end face 302 of the transmission line fiber 300 and the core 121b at the end face 122-1 of the MC-EDF 120.

The one side 111a of the double-sided mirror 111 is disposed in such a way as to face the core 201a at the end face 202 of the transmission line fiber 200 and the core 121b at the end face 122-1 of the MC-EDF 120. The one side 111a of the double-sided mirror 111 is fixed at an angle of 45 degrees with respect to the central axis line of the core 201a at the end face 202 of the transmission line fiber 200 and the central axis line of the core 121b at the end face 122-1 of the MC-EDF 120. The one side 111a of the double-sided mirror 111 reflects, at a right angle, light from the core 201a at the end face 202 of the transmission line fiber 200 toward the core 121b at the end face 122-1 of the MC-EDF 120.

The one side 111b of the double-sided mirror 111 is disposed in such a way as to face the core 301b at the end face 302 of the transmission line fiber 300 and the core 121b at the end face 122-2 of the MC-EDF 120. The one side 111b of the double-sided mirror 111 is fixed at an angle of 45 degrees with respect to the central axis line of the core 301b at the end face 302 of the transmission line fiber 300 and the central axis line of the core 121b at the end face 122-2 of the MC-EDF 120. The one side 111b of the double-sided mirror 111 reflects, at a right angle, light from the core 121b at the end face 122-2 of the MC-EDF 120 toward the core 301b at the end face 302 of the transmission line fiber 300.

The signal light output from the core 201b at the end face 202 of the transmission line fiber 200 is input to the core 121a at the end face 122-2 of the MC-EDF 120. The signal light input to the core 121a at the end face 122-2 of the MC-EDF 120 propagates through the MC-EDF 120 and is amplified, and the amplified signal light is output from the core 121a at the end face 122-1 to the core 301a at the end face 302 of the transmission line fiber 300.

The signal light output from the core 201a at the end face 202 of the transmission line fiber 200 is reflected by one side 111a of the double-sided mirror 111, and the reflected signal light is input to the core 121b at the end face 122-1 from the one side 111a. The signal light input to the core 121b at the end face 122-1 propagates through the MC-EDF 120 and is amplified, and the amplified signal light is output from the core 121b at the end face 122-1 toward the double-sided mirror 111. The signal light output from the core 121b is reflected by the one side 111b of the double-sided mirror 111, and is output from the one side 111b to the core 301b at the end face 302 of the transmission line fiber 300.

As described above, in a case where the transmission direction of the two-core MC-EDF is switched in the optical amplification apparatus, a twist of 180 degrees may be applied to the MC-EDF. Even in such a case, the transmission direction of the MC-EDF can be switched to bidirectional transmission by disposing a mirror and a core for switching the transmission direction in the two-core MC-EDF, in such a way as to have a predetermined positional relationship.

### Third Example Embodiment

Next, a third example embodiment is described. In the present example embodiment, an example in which a four-core MC-EDF is used is described as a specific example of the optical amplification apparatus described in the first example embodiment.

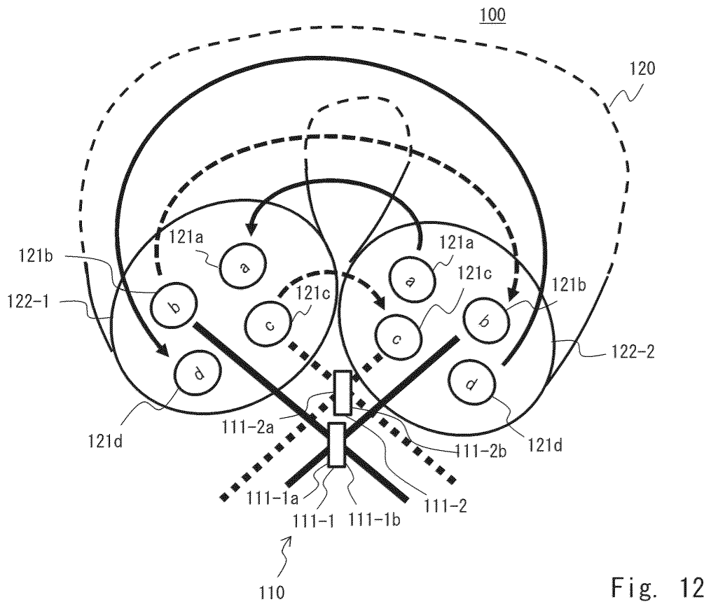

A transmission direction switching principle of an optical amplification apparatus 100 according to some example embodiments is described with reference to FIG. 12. FIG. 12 is a front view of end faces 122-1 and 122-2 of an MC-EDF 120.

In the example of FIG. 12, the MC-EDF 120 is a four-core MC-EDF. That is, the MC-EDF 120 includes cores 121a to 121d. Signal light is bidirectionally input and output to and from the cores 121a to 121d at the end faces 122-1 and 122-2 at both ends of the MC-EDF 120. In bidirectional transmission, the transmission direction in adjacent cores is set to be the reverse direction.

In the example of FIG. 12, the end face 122-1 and the end face 122-2 of the MC-EDF 120 face each other at a predetermined angle in a state where the MC-EDF 120 is folded back. That is, the MC-EDF 120 is folded back without being twisted. The end face 122-1 and the end face 122-2 face each other without rotating. For example, the cores 121a and 121c at the end face 122-1 and the cores 121a and 121c at the end face 122-2 are located on the inner side of where the end face 122-1 and the end face 122-2 face each other. For example, the core 121a is located on the upper side (inner upper side) of the end faces 122-1 and 122-2, and the core 121c is located on the lower side (inner lower side) of the end faces 122-1 and 122-2. If the end face 122-1 and the end face 122-2 face each other, it can also be said that the core 121a of the end face 122-1 and the core 121a of the end face 122-2 oppose each other, and the core 121c of the end face 122-1 and the core 121c the end face 122-2 oppose each other.

The cores 121b and 121d at the end face 122-1 and the cores 121b and 121d at the end face 122-2 are located on the outer side of where the end face 122-1 and the end face 122-2 face each other. For example, the core 121b is located on the upper side (outer upper side) of the end faces 122-1 and 122-2, and the core 121d is located on the lower side (outer lower side) of the end faces 122-1 and 122-2. If the end face 122-1 and the end face 122-2 face each other, it can also be said that the core 121b at the end face 122-1 and the core 121b at the end face 122-2 oppose each other, and the core 121d at the end face 122-1 and the core 121d at the end face 122-2 oppose each other.

In the example of FIG. 12, the cores 121a and 121d are cores in which transmission directions do not change, and the cores 121b and 121c are cores in which transmission directions change. Combinations of a core with no transmission direction change and a core with a transmission direction change is not limited to this. Combinations of other cores may be used as long as the traveling direction of light propagating between adjacent cores can be reversed. Thus, inter-core crosstalk can be effectively reduced.

As illustrated in FIG. 12, in a case where the end face 122-1 and the end face 122-2 of the MC-EDF 120 face each other at a certain angle, double-sided mirrors 111-1 and 111-2 are disposed at an intersection of the cores 121b that change the transmission direction in the MC-EDF 120 and the intersection of the cores 121c. Specifically, the double-sided mirror 111-1 is disposed at an intersection of the central axis line of the core 121b that changes the transmission direction in the MC-EDF 120, and the double-sided mirror 111-2 is disposed at an intersection of the central axis of the core 121c that changes the transmission direction in the MC-EDF 120. Thus, the transmission direction of the signal light of the cores 121b and 121c can be switched in the reverse direction with respect to the transmission direction of the cores 121a and 121d.

In a path of the core 121a, signal light is input to the core 121a at the end face 122-2, and the signal light amplified by the MC-EDF 120 is output from the core 121a at the end face 122-1. Further, in a path of the core 121b, input signal light is reflected by one side 111-1a of the double-sided mirror 111-1, is input to the core 121b at the end face 122-1, and the signal light amplified by the MC-EDF 120 is output from the core 121b at the end face 122-1. The signal light output from the core 121b is reflected by and output from the other one side 111-1b of the double-sided mirror 111-1.

In a path of the core 121c, input signal light is reflected by one side 111-2a of the double-sided mirror 111-2, is input to the core 121c at the end face 122-1, and the signal light amplified by the MC-EDF 120 is output from the core 121c at the end face 122-1. The signal light output from the core 121c is reflected by and output from the other one side 111-2b of the double-sided mirror 111-2. In a path of the core 121d, signal light is input to the core 121d at the end face 122-2, and the signal light amplified by the MC-EDF 120 is output from the core 121d at the end face 122-1.

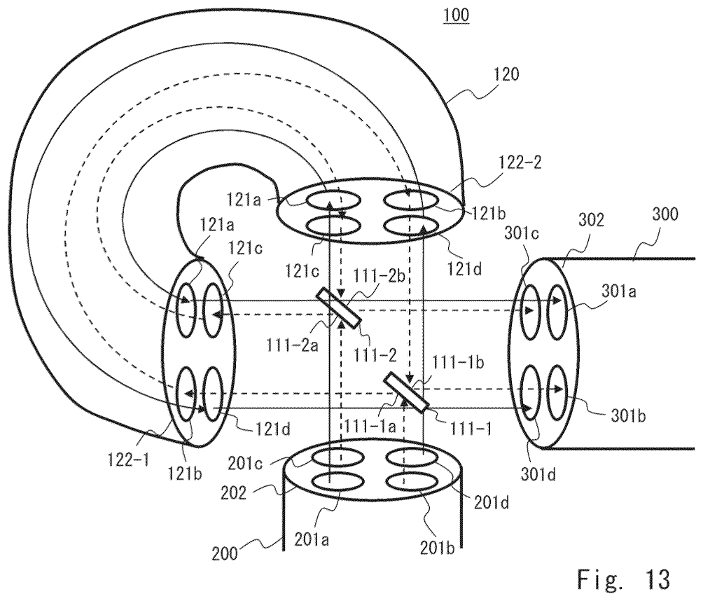

FIG. 13 illustrates a specific configuration example of the optical amplification apparatus 100 described with reference to FIG. 12. FIG. 13 is a top view of the end faces 122-1 and 122-2 of the MC-EDF 120.

In the example of FIG. 13, the end face 122-1 and the end face 122-2 of the MC-EDF 120 are fixed in such a way as to face each other at a right angle. For example, the MC-EDF 120 is folded back without being twisted, and the end face 122-1 and the end face 122-2 are fixed in such a way as to face each other at right angles. The MC-EDF 120 may be circulated to draw out the end face 122-1 and the end face 122-2 as necessary. The MC-EDF 120 may be twisted by 360 degrees×n (n is an integer).

As described with reference to FIG. 12, the cores 121a and 121c at the end face 122-1 and the cores 121a and 121c at the end face 122-2 are located on the inner side of where the end face 122-1 and the end face 122-2 face each other. The cores 121b and 121d at the end face 122-1 and the cores 121b and 121d at the end face 122-2 are located on the outer side of where the end face 122-1 and the end face 122-2 face each other.

In the example of FIG. 13, an input-side transmission line fiber 200 is fixed in such a way that an end face 202 of the transmission line fiber 200 faces the end face 122-2 of the MC-EDF 120. Specifically, a core 201a at the end face 202 of the transmission line fiber 200 faces the core 121a at the end face 122-2 of the MC-EDF 120. It can also be said that the central axis line of the core 201a at the end face 202 of the transmission line fiber 200 overlaps with the central axis line of the core 121a at the end face 122-2 of the MC-EDF 120. A core 201b at the end face 202 of the transmission line fiber 200 faces the core 121b at the end face 122-2 of the MC-EDF 120. It can also be said that the central axis line of the core 201b at the end face 202 of the transmission line fiber 200 overlaps with the central axis line of the core 121b at the end face 122-2 of the MC-EDF 120.

A core 201c at the end face 202 of the transmission line fiber 200 faces the core 121c at the end face 122-2 of the MC-EDF 120. It can also be said that the central axis line of the core 201c at the end face 202 of the transmission line fiber 200 overlaps with the central axis line of the core 121c at the end face 122-2 of the MC-EDF 120. A core 201d at the end face 202 of the transmission line fiber 200 faces the core 121d at the end face 122-2 of the MC-EDF 120. It can also be said that the central axis line of the core 201d at the end face 202 of the transmission line fiber 200 overlaps with the central axis line of the core 121d at the end face 122-2 of the MC-EDF 120.

An output-side transmission line fiber 300 is fixed in such a way that an end face 302 of the transmission line fiber 300 faces the end face 122-1 of the MC-EDF 120. Specifically, a core 301a at the end face 302 of the transmission line fiber 300 faces the core 121a at the end face 122-1 of the MC-EDF 120. It can also be said that the central axis line of the core 301a at the end face 302 of the transmission line fiber 300 overlaps with the central axis line of the core 121a at the end face 122-1 of the MC-EDF 120. A core 301b at the end face 302 of the transmission line fiber 300 faces the core 121b at the end face 122-1 of the MC-EDF 120. It can also be said that the central axis line of the core 301b at the end face 302 of the transmission line fiber 300 overlaps with the central axis line of the core 121b at the end face 122-1 of the MC-EDF 120.

A core 301c at the end face 302 of the transmission line fiber 300 faces the core 121c at the end face 122-1 of the MC-EDF 120. It can also be said that the central axis line of the core 301c at the end face 302 of the transmission line fiber 300 overlaps with the central axis line of the core 121c at the end face 122-1 of the MC-EDF 120. A core 301d at the end face 302 of the transmission line fiber 300 faces the core 121d at the end face 122-1 of the MC-EDF 120. It can also be said that the central axis line of the core 301d at the end face 302 of the transmission line fiber 300 overlaps with the central axis line of the core 121d at the end face 122-1 of the MC-EDF 120.

As described in FIG. 12, for example, the cores 121b and 121c of the MC-EDF 120 are cores in which the transmission direction change. Therefore, the double-sided mirror 111-1 is disposed at an intersection of the central axis line of the core 121b at the end face 122-2 of the MC-EDF 120 and the central axis line of the core 121b at the end face 122-1 of the MC-EDF 120. It can also be said that the double-sided mirror 111-1 is disposed at an intersection of a central axis line connecting the core 201b at the end face 202 of the transmission line fiber 200 and the core 121b at the end face 122-2 of the MC-EDF 120, and a central axis line connecting the core 301b at the end face 302 of the transmission line fiber 300 and the core 121b at the end face 122-1 of the MC-EDF 120.

The double-sided mirror 111-2 is disposed at an intersection of the central axis line of the core 121c at the end face 122-2 of the MC-EDF 120 and the central axis line of the core 121c at the end face 122-1 of the MC-EDF 120. It can also be said that the double-sided mirror 111-2 is disposed at an intersection of a central axis line connecting the core 201c at the end face 202 of the transmission line fiber 200 and the core 121c at the end face 122-2 of the MC-EDF 120, and a central axis line connecting the core 301c at the end face 302 of the transmission line fiber 300 and the core 121c at the end face 122-1 of the MC-EDF 120.

The one side 111-1a of the double-sided mirror 111-1 is disposed in such a way as to face the core 201b at the end face 202 of the transmission line fiber 200 and the core 121b at the end face 122-1 of the MC-EDF 120. The one side 111-1a of the double-sided mirror 111-1 is fixed at an angle of 45 degrees with respect to the central axis line of the core 201b at the end face 202 of the transmission line fiber 200 and the central axis line of the core 121b at the end face 122-1 of the MC-EDF 120. The one side 111-1a of the double-sided mirror 111-1 reflects, at a right angle, light from the core 201b at the end face 202 of the transmission line fiber 200 toward the core 121b at the end face 122-1 of the MC-EDF 120.

The one side 111-1b of the double-sided mirror 111-1 is disposed in such a way as to face the core 301b at the end face 302 of the transmission line fiber 300 and the core 121b at the end face 122-2 of the MC-EDF 120. The one side 111-1b of the double-sided mirror 111-1 is fixed at an angle of 45 degrees with respect to the central axis line of the core 301b at the end face 302 of the transmission line fiber 300 and the central axis line of the core 121b at the end face 122-2 of the MC-EDF 120. The one side 111-1b of the double-sided mirror 111-1 reflects, at a right angle, light from the core 121b at the end face 122-2 of the MC-EDF 120 toward the core 301b at the end face 302 of the transmission line fiber 300.

The one side 111-2a of the double-sided mirror 111-2 is disposed in such a way as to face the core 201c at the end face 202 of the transmission line fiber 200 and the core 121c at the end face 122-1 of the MC-EDF 120. The one side 111-2a of the double-sided mirror 111-2 is fixed at an angle of 45 degrees with respect to the central axis line of the core 201c at the end face 202 of the transmission line fiber 200 and the central axis line of the core 121c at the end face 122-1 of the MC-EDF 120. The one side 111-2a of the double-sided mirror 111-2 reflects, at a right angle, light from the core 201c at the end face 202 of the transmission line fiber 200 toward the core 121c at the end face 122-1 of the MC-EDF 120.

The one side 111-2b of the double-sided mirror 111-2 is disposed in such a way as to face the core 301c at the end face 302 of the transmission line fiber 300 and the core 121c at the end face 122-2 of the MC-EDF 120. The one side 111-2b of the double-sided mirror 111-2 is fixed at an angle of 45 degrees with respect to the central axis line of the core 301c at the end face 302 of the transmission line fiber 300 and the central axis line of the core 121c at the end face 122-2 of the MC-EDF 120. The one side 111-2b of the double-sided mirror 111-2 reflects, at a right angle, light from the core 121c at the end face 122-2 of the MC-EDF 120 toward the core 301c at the end face 302 of the transmission line fiber 300.

The signal light output from the core 201a at the end face 202 of the transmission line fiber 200 is input to the core 121a at the end face 122-2 of the MC-EDF 120. The signal light input to the core 121a at the end face 122-2 of the MC-EDF 120 propagates through the MC-EDF 120 and is amplified, and the amplified signal light is output from the core 121a at the end face 122-1 to the core 301a at the end face 302 of the transmission line fiber 300.

The signal light output from the core 201b at the end face 202 of the transmission line fiber 200 is reflected by the one side 111-1a of the double-sided mirror 111-1, and is input from the one side 111-1a to the core 121b at the end face 122-1. The signal light input to the core 121b at the end face 122-1 propagates through the MC-EDF 120 and is amplified, and the amplified signal light is output from the core 121b at the end face 122-1 toward the double-sided mirror 111-1. The signal light output from the core 121b is reflected by the one side 111-1b of the double-sided mirror 111-1, and is output from the one side 111-1b to the core 301b at the end face 302 of the transmission line fiber 300.

The signal light output from the core 201c at the end face 202 of the transmission line fiber 200 is reflected by the one side 111-2a of the double-sided mirror 111-2, and is input from the one side 111-2a to the core 121c at the end face 122-1. The signal light input to the core 121c at the end face 122-1 propagates through the MC-EDF 120 and is amplified, and the amplified signal light is output from the core 121c at the end face 122-1 toward the double-sided mirror 111-2. The signal light output from the core 121c is reflected by the one face 111-2b of the double-sided mirror 111-2, and is output from the one face 111-2b to the core 301c at the end face 302 of the transmission line fiber 300.

The signal light output from the core 201d at the end face 202 of the transmission line fiber 200 is input to the core 121d at the end face 122-2 of the MC-EDF 120. The signal light input to the core 121d at the end face 122-2 of the MC-EDF 120 propagates through the MC-EDF 120 and is amplified, and the amplified signal light is output from the core 121d at the end face 122-1 to the core 301d at the end face 302 of the transmission line fiber 300.

As described above, in a case where the transmission direction of the MC-EDF is switched in the optical amplification apparatus, the four-core MC-EDF may be used. Even in such a case, the transmission direction of the MC-EDF can be switched to bidirectional transmission by disposing a mirror and a core that switches the transmission direction in the four-core MC-EDF, in such a way as to have a predetermined positional relationship.

### First Modified Example of Third Example Embodiment

In a first modified example of the third example embodiment, an example in which 90 degrees of twist is applied to the MC-EDF 120 in the optical amplification apparatus 100 illustrated in the third example embodiment is described.

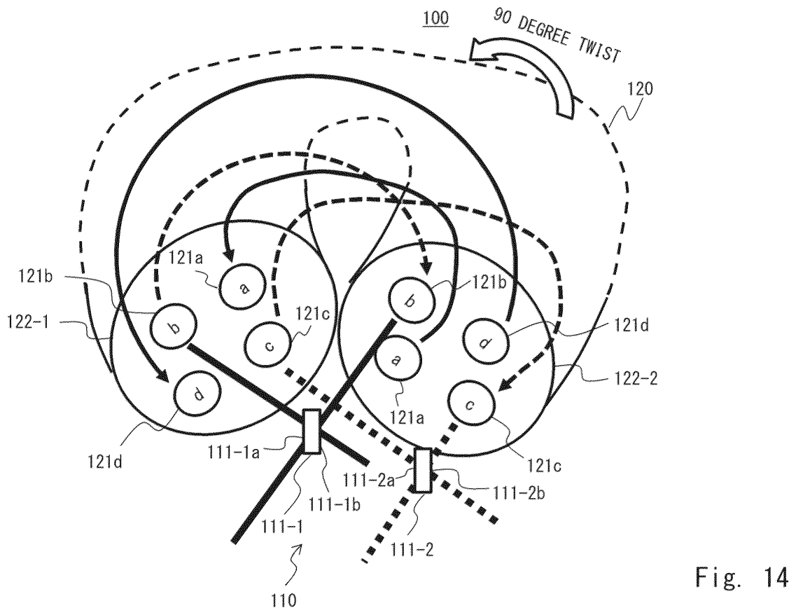

A transmission direction switching principle of the optical amplification apparatus 100 according to some example embodiments is described with reference to FIG. 14. FIG. 14 is a front view of the end faces 122-1 and 122-2 of the MC-EDF 120.

In the example of FIG. 14, the positional relationship between the cores 121a to 121d at the end faces 122-1 and 122-2 of the MC-EDF 120 is different from that in FIG. 12. That is, the MC-EDF 120 is folded back with a 90 degree twist about the central axis of the fiber. The end face 122-1 and the end face 122-2 of the MC-EDF 120 face each other at a predetermined angle in a state where the MC-EDF 120 is folded back while being twisted by 90 degrees. It can also be said that the end face 122-1 and the end face 122-2 face each other in a state where either one is rotated by 90 degrees. The 90 degrees of twist is an angle at which the core 121 rotates, from a state in which the end face 122 is not rotated (FIG. 12), to the position of the adjacent core 121.

For example, the cores 121a and 121c at the end face 122-1 and the cores 121b and 121a at the end face 122-2 are located on the inner side of where the end face 122-1 and the end face 122-2 face each other. For example, the core 121a is located on the upper side (inner upper side) of the end face 122-1, the core 121c is located on the lower side (inner lower side) of the end face 122-1, the core 121b is located on the upper side (inner upper side) of the end face 122-2, and the core 121a is located on the lower side (inner lower side) of the end face 122-2. If the end face 122-1 and the end face 122-2 face each other, it can also be said that the core 121a of the end face 122-1 and the core 121b of the end face 122-2 oppose each other, and the core 121c at the end face 122-1 and the core 121a at the end face 122-2 oppose each other. The cores 121b and 121d at the end face 122-1 and the cores 121d and 121c at the end face 122-2 are located on the outer side of where the end face 122-1 and the end face 122-2 face each other. For example, the core 121b is located on the upper side (outer upper side) of the end face 122-1, the core 121d is located on the lower side (outer lower side) of the end face 122-1, the core 121d is located on the upper side (outer upper side) of the end face 122-2, and the core 121c is located on the lower side (outer lower side) of the end face 122-2. If the end face 122-1 and the end face 122-2 face each other, it can also be said that the core 121b at the end face 122-1 and the core 121d at the end face 122-2 oppose each other, and the core 121d at the end face 122-1 and the core 121c at the end face 122-2 oppose each other.

Similarly to FIG. 12, in a case where the end face 122-1 and the end face 122-2 of the MC-EDF 120 face each other at a certain angle, the double-sided mirror 111-1 is disposed at an intersection of the cores 121b that change the transmission direction in the MC-EDF 120, and the double-sided mirror 111-2 is disposed at an intersection of the cores 121c that change the transmission direction in the MC-EDF 120. In the example of FIG. 14, since the positions of the cores 121b and 121c at the end face 122-2 are different from those of FIG. 12, the positions of the double-sided mirrors 111-1 and 111-2 are shifted from those of FIG. 12. That is, the double-sided mirror 111-1 is disposed at an intersection of the central axis line of the core 121b at the end face 122-2, being on the inner upper side of where the end face 122-1 and the end face 122-2 face each other, and the central axis line of the core 121b at the end face 122-1, being on the outer upper side of where the end face 122-1 and the end face 122-2 face each other. The double-sided mirror 111-2 is disposed at an intersection of a central axis line of the core 121c at the end face 122-2, being on the outer lower side of where the end face 122-1 and the end face 122-2 face each other, and a central axis line of the core 121c at the end face 122-1, being on the inner lower side of where the end face 122-1 and the end face 122-2 face each other.

As illustrated in FIG. 14, in a path of the core 121a, signal light is input to the core 121a at the end face 122-2, being on the inner lower side of where the end face 122-1 and the end face 122-2 face each other, and the signal light amplified by the MC-EDF 120 is output from the core 121a at the end face 122-1, being on the inner upper side of where the end face 122-1 and the end face 122-2 face each other.

In a path of the core 121b, input signal light is reflected by the one side 111-1a of the double-sided mirror 111-1, the reflected signal light is input to the core 121b at the end face 122-1, being on the outer upper side of where the end face 122-1 and the end face 122-2 face each other, and the signal light amplified by the MC-EDF 120 is output from the core 121b at the end face 122-1, being on the inner upper side of where the end face 122-1 and the end face 122-2 face each other. The signal light output from the core 121b is reflected by and output from the other one side 111-1b of the double-sided mirror 111-1.

In a path of the core 121c, input signal light is reflected by the one side 111-2a of the double-sided mirror 111-2, the reflected signal light is input to the core 121c at the end face 122-1, being on the inner lower side of where the end face 122-1 and the end face 122-2 face each other, and the signal light amplified by the MC-EDF 120 is output from the core 121c at the end face 122-1, being on the outer lower side of where the end face 122-1 and the end face 122-2 face each other. The signal light output from the core 121c is reflected by and output from the other one side 111-2b of the double-sided mirror 111-2.

In a path of the core 121d, signal light is input to the core 121d at the end face 122-2, being on the outer upper side of where the end face 122-1 and the end face 122-2 face each other, and the signal light amplified by the MC-EDF 120 is output from the core 121d at the end face 122-1, being on the outer lower side of where the end face 122-1 and the end face 122-2 face each other.

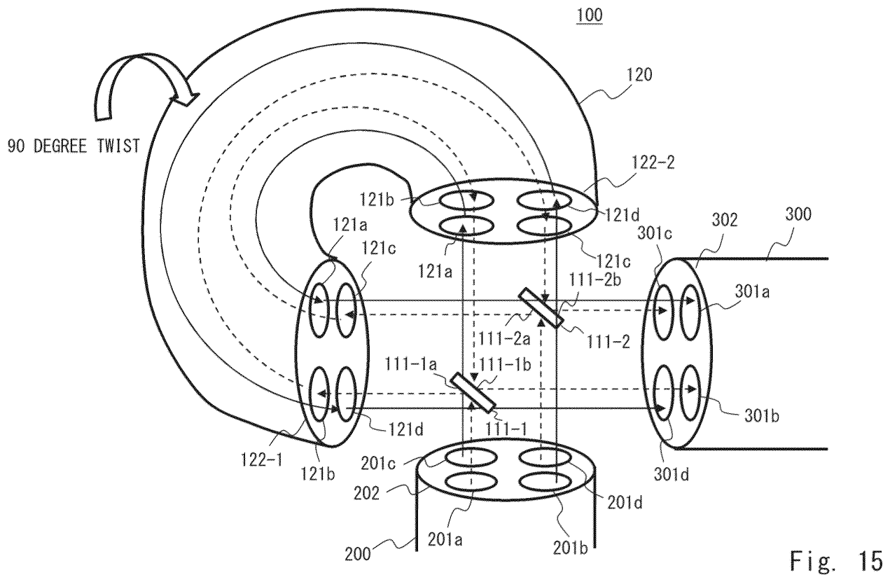

FIG. 15 illustrates a specific configuration example of the optical amplification apparatus 100 described with reference to FIG. 14. FIG. 15 is a top view of the end faces 122-1 and 122-2 of the MC-EDF 120.

In the example of FIG. 15, the positions of the cores 121a to 121d in the end faces 122-1 and 122-2 of the MC-EDF 120 and the double-sided mirrors 111-1 and 111-2 are different from those in FIG. 13.

In the example of FIG. 15, the end face 122-1 and the end face 122-2 of the MC-EDF 120 are fixed in such a way as to face each other at a right angle. For example, the MC-EDF 120 is folded back with a twist of 90 degrees, and the end face 122-1 and the end face 122-2 are fixed in such a way as to face each other at right angles. The MC-EDF 120 may be circulated to draw out the end face 122-1 and the end face 122-2 as necessary. The MC-EDF 120 may be twisted by 90 degrees+360 degrees×n (n is an integer).

As described with reference to FIG. 14, the cores 121a and 121c at the end face 122-1 and the cores 121b and 121a at the end face 122-2 are located on the inner side of where the end face 122-1 and the end face 122-2 face each other. The cores 121b and 121d at the end face 122-1 and the cores 121d and 121c at the end face 122-2 are located on the outer side of where the end face 122-1 and the end face 122-2 face each other.

Similarly to FIG. 13, the input-side transmission line fiber 200 is fixed in such a way that the end face 202 of the transmission line fiber 200 faces the end face 122-2 of the MC-EDF 120. The output-side transmission line fiber 300 is fixed in such a way that the end face 302 of the transmission line fiber 300 faces the end face 122-1 of the MC-EDF 120.

As described in FIG. 14, for example, the cores 121b and 121c of the MC-EDF 120 are cores in which the transmission direction change. Therefore, the double-sided mirror 111-1 is disposed at an intersection of the central axis line of the core 121b at the end face 122-2 of the MC-EDF 120, being on the inner upper side of where the end face 122-1 and the end face 122-2 face each other, and the central axis line of the core 121b at the end face 122-1 of the MC-EDF 120, being on the outer upper side of where the end face 122-1 and the end face 122-2 face each other. It can also be said that the double-sided mirror 111-1 is disposed at an intersection of a central axis line connecting the core 201a at the end face 202 of the transmission line fiber 200 and the core 121b at the end face 122-2 of the MC-EDF 120, and a central axis line connecting the core 301b at the end face 302 of the transmission line fiber 300 and the core 121b at the end face 122-1 of the MC-EDF 120.

The double-sided mirror 111-2 is disposed at an intersection of the central axis line of the core 121c at the end face 122-2 of the MC-EDF 120, being on the outer lower side of where the end face 122-1 and the end face 122-2 face each other, and the central axis line of the core 121c at the end face 122-1 of the MC-EDF 120, being on the inner lower side of where the end face 122-1 and the end face 122-2 face each other. It can also be said that the double-sided mirror 111-2 is disposed at an intersection of a central axis line connecting the core 201d at the end face 202 of the transmission line fiber 200 and the core 121c at the end face 122-2 of the MC-EDF 120, and a central axis line connecting the core 301c at the end face 302 of the transmission line fiber 300 and the core 121c at the end face 122-1 of the MC-EDF 120.

The one side 111-1a of the double-sided mirror 111-1 is disposed in such a way as to face the core 201a at the end face 202 of the transmission line fiber 200 and the core 121b at the end face 122-1 of the MC-EDF 120. The one side 111-1a of the double-sided mirror 111-1 is fixed at an angle of 45 degrees with respect to the central axis of the core 201a at the end face 202 of the transmission line fiber 200 and the central axis of the core 121b at the end face 122-1 of the MC-EDF 120. The one side 111-1a of the double-sided mirror 111-1 reflects, at a right angle, light from the core 201a at the end face 202 of the transmission line fiber 200 toward the core 121b at the end face 122-1 of the MC-EDF 120.

The one side 111-1b of the double-sided mirror 111-1 is disposed in such a way as to face the core 301b at the end face 302 of the transmission line fiber 300 and the core 121b at the end face 122-2 of the MC-EDF 120. The one side 111-1b of the double-sided mirror 111-1 is fixed at an angle of 45 degrees with respect to the central axis of the core 301b at the end face 302 of the transmission line fiber 300 and the central axis of the core 121b at the end face 122-2 of the MC-EDF 120. The one side 111-1b of the double-sided mirror 111-1 reflects, at a right angle, light from the core 121b at the end face 122-2 of the MC-EDF 120 toward the core 301b at the end face 302 of the transmission line fiber 300.

The one side 111-2a of the double-sided mirror 111-2 is disposed in such a way as to face the core 201d at the end face 202 of the transmission line fiber 200 and the core 121c at the end face 122-1 of the MC-EDF 120. The one side 111-2a of the double-sided mirror 111-2 is fixed at an angle of 45 degrees with respect to the central axis of the core 201d at the end face 202 of the transmission line fiber 200 and the central axis of the core 121c at the end face 122-1 of the MC-EDF 120. The one side 111-2a of the double-sided mirror 111-2 reflects, at a right angle, light from the core 201d at the end face 202 of the transmission line fiber 200 toward the core 121c at the end face 122-1 of the MC-EDF 120.

The one side 111-2b of the double-sided mirror 111-2 is disposed in such a way as to face the core 301c at the end face 302 of the transmission line fiber 300 and the core 121c at the end face 122-2 of the MC-EDF 120. The one side 111-2b of the double-sided mirror 111-2 is fixed at an angle of 45 degrees with respect to the central axis of the core 301c at the end face 302 of the transmission line fiber 300 and the central axis of the core 121c at the end face 122-2 of the MC-EDF 120. The one side 111-2b of the double-sided mirror 111-2 reflects, at a right angle, light from the core 121c at the end face 122-2 of the MC-EDF 120 toward the core 301c at the end face 302 of the transmission line fiber 300.

The signal light output from the core 201c at the end face 202 of the transmission line fiber 200 is input to the core 121a at the end face 122-2 of the MC-EDF 120. The signal light input to the core 121a at the end face 122-2 of the MC-EDF 120 propagates through the MC-EDF 120 and is amplified, and the amplified signal light is output from the core 121a at the end face 122-1 to the core 301a at the end face 302 of the transmission line fiber 300.

The signal light output from the core 201a at the end face 202 of the transmission line fiber 200 is reflected by the one side 111-1a of the double-sided mirror 111-1, and is input from the one side 111-1a to the core 121b at the end face 122-1. The signal light input to the core 121b at the end face 122-1 propagates through the MC-EDF 120 and is amplified, and the amplified signal light is output from the core 121b at the end face 122-1 toward the double-sided mirror 111-1. The signal light output from the core 121b is reflected by the one side 111-1b of the double-sided mirror 111-1, and is output from the one side 111-1b to the core 301b at the end face 302 of the transmission line fiber 300.

The signal light output from the core 201d at the end face 202 of the transmission line fiber 200 is reflected by the one side 111-2a of the double-sided mirror 111-2, and is input from the one side 111-2a to the core 121c at the end face 122-1. The signal light input to the core 121c at the end face 122-1 propagates through the MC-EDF 120 and is amplified, and the amplified signal light is output from the core 121c at the end face 122-1 toward the double-sided mirror 111-2. The signal light output from the core 121c is reflected by the one face 111-2b of the double-sided mirror 111-2, and is output from the one face 111-2b to the core 301c at the end face 302 of the transmission line fiber 300.

The signal light output from the core 201b at the end face 202 of the transmission line fiber 200 is input to the core 121d at the end face 122-2 of the MC-EDF 120. The signal light input to the core 121d at the end face 122-2 of the MC-EDF 120 propagates through the MC-EDF 120 and is amplified, and the amplified signal light is output from the core 121d at the end face 122-1 to the core 301d at the end face 302 of the transmission line fiber 300.

As described above, in a case where the transmission direction of the four-core MC-EDF is switched in the optical amplification apparatus, a twist of 90 degrees may be applied to the MC-EDF. Even in such a case, the transmission direction of the MC-EDF can be switched to bidirectional transmission by disposing a mirror and a core for switching the transmission direction in the four-core MC-EDF, in such a way as to have a predetermined positional relationship.

### Second Modified Example of Third Example Embodiment

In a second modified example of the third example embodiment, an example in which 180 degrees of twist is applied to the MC-EDF 120 in the optical amplification apparatus 100 illustrated in the third example embodiment is described.

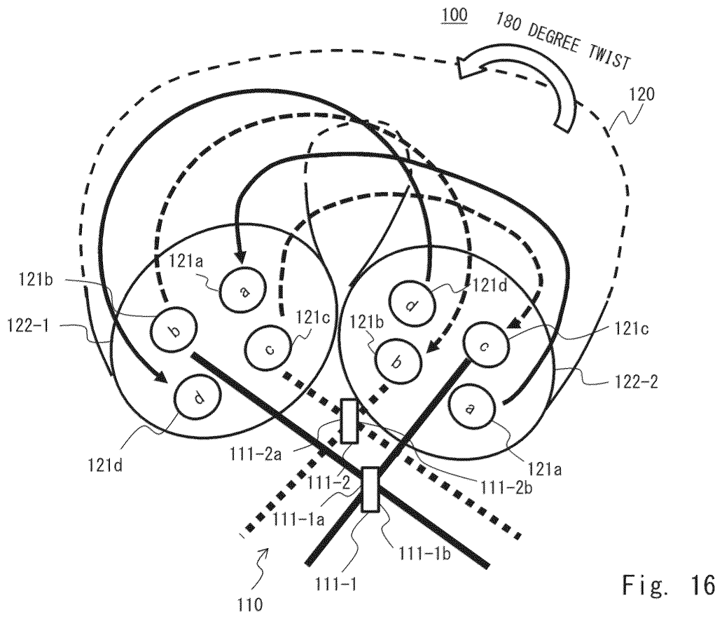

A transmission direction switching principle of the optical amplification apparatus 100 according to some example embodiments is described with reference to FIG. 16. FIG. 16 is a front view of the end faces 122-1 and 122-2 of the MC-EDF 120.

In the example of FIG. 16, the positional relationship between the cores 121a to 121d at the end faces 122-1 and 122-2 of the MC-EDF 120 is different from that in FIG. 12. That is, the MC-EDF 120 is folded back with a 180 degree twist about the central axis of the fiber. The end face 122-1 and the end face 122-2 of the MC-EDF 120 face each other in a state where the MC-EDF 120 is folded back while being twisted by 180 degrees. It can also be said that the end face 122-1 and the end face 122-2 face each other while either one is rotated by 180 degrees. The 180 degrees of twist is an angle at which the core 121 rotates, from a state in which the end face 122 is not rotated (FIG. 12), to the position of a core 121 being two cores away.

For example, the cores 121a and 121c at the end face 122-1 and the cores 121d and 121b at the end face 122-2 are located on the inner side of where the end face 122-1 and the end face 122-2 face each other. For example, the core 121a is located on the upper side (inner upper side) of the end face 122-1, the core 121c is located on the lower side (inner lower side) of the end face 122-1, the core 121d is located on the upper side (inner upper side) of the end face 122-2, and the core 121b is located on the lower side (inner lower side) of the end face 122-2. If the end face 122-1 and the end face 122-2 face each other, it can also be said that the core 121a and the end face 122-1 and the core 121d of the end face 122-2 oppose each other, and the core 121c at the end face 122-1 and the core 121b at the end face 122-2 oppose each other. The cores 121b and 121d at the end face 122-1 and the cores 121c and 121a at the end face 122-2 are located on the outer side of where the end face 122-1 and the end face 122-2 face each other. For example, the core 121b is located on the upper side (outer upper side) of the end face 122-1, the core 121d is located on the lower side (outer lower side) of the end face 122-1, the core 121c is located on the upper side (outer upper side) of the end face 122-2, and the core 121a is located on the lower side (outer lower side) of the end face 122-2. If the end face 122-1 and the end face 122-2 face each other, it can also be said that the core 121b at the end face 122-1 and the core 121c at the end face 122-2 oppose each other, and the core 121d at the end face 122-1 and the core 121a at the end face 122-2 oppose each other.

In the example of FIG. 16, the cores 121b and 121c of the MC-EDF 120 are cores (group) in which the transmission direction change. As illustrated in FIG. 16, if the four-core MC-EDF 120 is twisted by 180 degrees and the end face 122-1 and the end face 122-2 face each other, the central axis lines of cores in which the transmission direction change do not intersect with each other. Therefore, in a case where the end face 122-1 and the end face 122-2 of the MC-EDF 120 face each other at a certain angle, the double-sided mirrors 111-1 and 111-2 are disposed at intersections of one core and the other core from the group of the cores 121b and 121c that change the transmission direction in the MC-EDF 120. That is, the double-sided mirror 111-1 is disposed at an intersection of the central axis line of the core 121b at the end face 122-2, being on the inner lower side of where the end face 122-1 and the end face 122-2 face each other, and the central axis line of the core 121c at the end face 122-1, being on the inner lower side of where the end face 122-1 and the end face 122-2 face each other. The double-sided mirror 111-2 is disposed at an intersection of the central axis line of the core 121c at the end face 122-2, being on the outer upper side of where the end face 122-1 and the end face 122-2 face each other, and a central axis line of the core 121b at the end face 122-1, being on the outer upper side of where the end face 122-1 and the end face 122-2 face each other.

As illustrated in FIG. 16, in a path of the core 121a, signal light is input to the core 121a at the end face 122-2, being on the outer lower side of where the end face 122-1 and the end face 122-2 face each other, and the signal light amplified by the MC-EDF 120 is output from the core 121a at the end face 122-2, being on the inner upper side of where the end face 122-1 and the end face 122-2 face each other.

In a path of the core 121b, input signal light is reflected by the one side 111-1a of the double-sided mirror 111-1, the reflected signal light is input to the core 121b at the end face 122-1, being on the outer upper side of where the end face 122-1 and the end face 122-2 face each other, and the signal light amplified by the MC-EDF 120 is output from the core 121b at the end face 122-1, being on the inner lower side of where the end face 122-1 and the end face 122-2 face each other. The signal light output from the core 121b is reflected by and output from the other one side 111-2b of the double-sided mirror 111-2.

In a path of the core 121c, input signal light is reflected by the one side 111-2a of the double-sided mirror 111-2, the reflected signal light is input to the core 121c at the end face 122-1, being on the inner lower side of where the end face 122-1 and the end face 122-2 face each other, and the signal light amplified by the MC-EDF 120 is output from the core 121c at the end face 122-1, being on the outer upper side of where the end face 122-1 and the end face 122-2 face each other. The signal light output from the core 121c is reflected by and output from the other one side 111-2b of the double-sided mirror 111-1.

In a path of the core 121d, signal light is input to the core 121d at the end face 122-2, being on the inner upper side of where the end face 122-1 and the end face 122-2 face each other, and the signal light amplified by the MC-EDF 120 is output from the core 121d at the end face 122-1, being on the outer lower side of where the end face 122-1 and the end face 122-2 face each other.

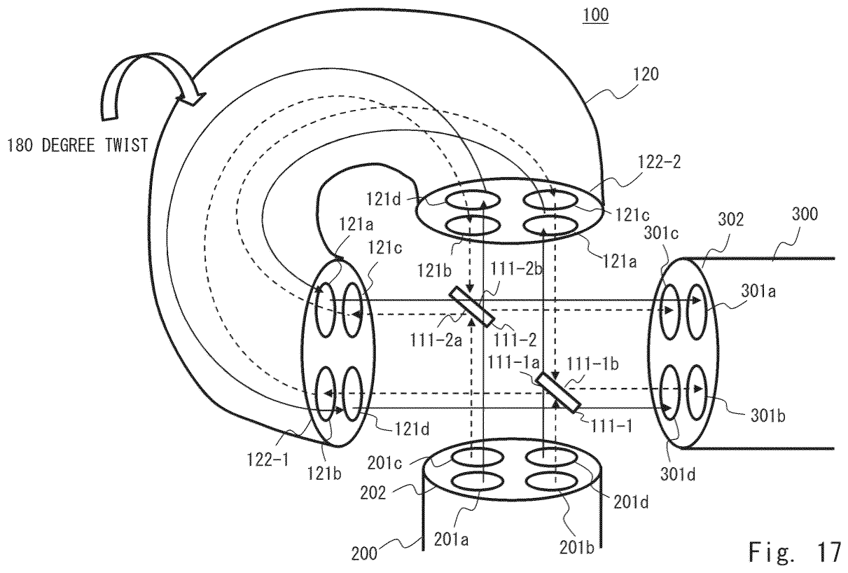

FIG. 17 illustrates a specific configuration example of the optical amplification apparatus 100 described with reference to FIG. 16. FIG. 17 is a top view of the end faces 122-1 and 122-2 of the MC-EDF 120.

In the example of FIG. 17, the positions of the cores 121a to 121d in the end faces 122-1 and 122-2 of the MC-EDF 120 and the double-sided mirrors 111-1 and 111-2 are different from those in FIG. 13.

In the example of FIG. 17, the end face 122-1 and the end face 122-2 of the MC-EDF 120 are fixed in such a way as to face each other at a right angle. For example, the MC-EDF 120 is folded back with a twist of 180 degrees, and the end face 122-1 and the end face 122-2 are fixed in such a way as to face each other at a right angle. The MC-EDF 120 may be circulated to draw out the end face 122-1 and the end face 122-2 as necessary. The MC-EDF 120 may be twisted by 180 degrees+360 degrees×n (n is an integer).

As described with reference to FIG. 16, the cores 121a and 121c at the end face 122-1 and the cores 121d and 121b at the end face 122-2 are located on the inner side of where the end face 122-1 and the end face 122-2 face each other. The cores 121b and 121d at the end face 122-1 and the cores 121c and 121a at the end face 122-2 are located on the outer side of where the end face 122-1 and the end face 122-2 face each other.

Similarly to FIG. 13, the input-side transmission line fiber 200 is fixed in such a way that the end face 202 of the transmission line fiber 200 faces the end face 122-2 of the MC-EDF 120. The output-side transmission line fiber 300 is fixed in such a way that the end face 302 of the transmission line fiber 300 faces the end face 122-1 of the MC-EDF 120.

As described in FIG. 16, the cores 121b and 121c of the MC-EDF 120 are, for example, cores (group) in which the transmission direction change. Therefore, the double-sided mirror 111-1 is disposed at an intersection of the central axis line of the core 121c at the end face 122-2 of the MC-EDF 120, being on the outer upper side of where the end face 122-1 and the end face 122-2 face each other, and the central axis line of the core 121b at the end face 122-1 of the MC-EDF 120, being on the outer upper side of where the end face 122-1 and the end face 122-2 face each other. It can also be said that the double-sided mirror 111-1 is disposed at an intersection of a central axis line connecting the core 201b at the end face 202 of the transmission line fiber 200 and the core 121c at the end face 122-2 of the MC-EDF 120, and a central axis line connecting the core 301b at the end face 302 of the transmission line fiber 300 and the core 121b at the end face 122-1 of the MC-EDF 120.

The double-sided mirror 111-2 is disposed at an intersection of the central axis line of the core 121b at the end face 122-2 of the MC-EDF 120, being on the inner lower side of where the end face 122-1 and the end face 122-2 face each other, and the central axis line of the core 121c at the end face 122-1 of the MC-EDF 120, being on the inner lower side of where the end face 122-1 and the end face 122-2 face each other. It can also be said that the double-sided mirror 111-2 is disposed at an intersection of a central axis line connecting the core 201c at the end face 202 of the transmission line fiber 200 and the core 121b at the end face 122-2 of the MC-EDF 120, and a central axis line connecting the core 301c at the end face 302 of the transmission line fiber 300 and the core 121c at the end face 122-1 of the MC-EDF 120.

The one side 111-1a of the double-sided mirror 111-1 is disposed in such a way as to face the core 201b at the end face 202 of the transmission line fiber 200 and the core 121b at the end face 122-1 of the MC-EDF 120. The one side 111-1a of the double-sided mirror 111-1 is fixed at an angle of 45 degrees with respect to the central axis line of the core 201b at the end face 202 of the transmission line fiber 200 and the central axis line of the core 121b at the end face 122-1 of the MC-EDF 120. The one side 111-1a of the double-sided mirror 111-1 reflects light, at a right angle, from the core 201b at the end face 202 of the transmission line fiber 200 toward the core 121b at the end face 122-1 of the MC-EDF 120.

The one side 111-1b of the double-sided mirror 111-1 is disposed in such a way as to face the core 301b at the end face 302 of the transmission line fiber 300 and the core 121c at the end face 122-2 of the MC-EDF 120. The one side 111-1b of the double-sided mirror 111-1 is fixed at an angle of 45 degrees with respect to the central axis line of the core 301b at the end face 302 of the transmission line fiber 300 and the central axis line of the core 121c at the end face 122-2 of the MC-EDF 120. The one side 111-1b of the double-sided mirror 111-1 reflects, at a right angle, light from the core 121c at the end face 122-2 of the MC-EDF 120 toward the core 301b at the end face 302 of the transmission line fiber 300.

The one side 111-2a of the double-sided mirror 111-2 is disposed in such a way as to face the core 201c at the end face 202 of the transmission line fiber 200 and the core 121c at the end face 122-1 of the MC-EDF 120. The one side 111-2a of the double-sided mirror 111-2 is fixed at an angle of 45 degrees with respect to the central axis line of the core 201c at the end face 202 of the transmission line fiber 200 and the central axis line of the core 121c at the end face 122-1 of the MC-EDF 120. The one side 111-2a of the double-sided mirror 111-2 reflects, at a right angle, light from the core 201c at the end face 202 of the transmission line fiber 200 toward the core 121c at the end face 122-1 of the MC-EDF 120.

The one side 111-2b of the double-sided mirror 111-2 is disposed in such a way as to face the core 301c at the end face 302 of the transmission line fiber 300 and the core 121b at the end face 122-2 of the MC-EDF 120. The one side 111-2b of the double-sided mirror 111-2 is fixed at an angle of 45 degrees with respect to the central axis line of the core 301c at the end face 302 of the transmission line fiber 300 and the central axis line of the core 121b at the end face 122-2 of the MC-EDF 120. The one side 111-2b of the double-sided mirror 111-2 reflects, at a right angle, light from the core 121b at the end face 122-2 of the MC-EDF 120 toward the core 301c at the end face 302 of the transmission line fiber 300.

The signal light output from the core 201d at the end face 202 of the transmission line fiber 200 is input to the core 121a at the end face 122-2 of the MC-EDF 120. The signal light input to the core 121a at the end face 122-2 of the MC-EDF 120 propagates through the MC-EDF 120 and is amplified, and the amplified signal light is output from the core 121a at the end face 122-1 to the core 301a at the end face 302 of the transmission line fiber 300.

The signal light output from the core 201b at the end face 202 of the transmission line fiber 200 is reflected by the one side 111-1a of the double-sided mirror 111-1, and is input from the one side 111-1a to the core 121b at the end face 122-1. The signal light input to the core 121b at the end face 122-1 propagates through the MC-EDF 120 and is amplified, and the amplified signal light is output from the core 121b at the end face 122-1 toward the double-sided mirror 111-2. The signal light output from the core 121b is reflected by the one face 111-2b of the double-sided mirror 111-2, and is output from the one face 111-2b to the core 301c at the end face 302 of the transmission line fiber 300.

The signal light output from the core 201c at the end face 202 of the transmission line fiber 200 is reflected by the one side 111-2a of the double-sided mirror 111-2, and is input from the one side 111-2a to the core 121c at the end face 122-1. The signal light input to the core 121c at the end face 122-1 propagates through the MC-EDF 120 and is amplified, and the amplified signal light is output from the core 121c at the end face 122-1 toward the double-sided mirror 111-1. The signal light output from the core 121c is reflected by the one side 111-1b of the double-sided mirror 111-1, and is output from the one side 111-1b to the core 301b at the end face 302 of the transmission line fiber 300.

The signal light output from the core 201a at the end face 202 of the transmission line fiber 200 is input to the core 121d at the end face 122-2 of the MC-EDF 120. The signal light input to the core 121d at the end face 122-2 of the MC-EDF 120 propagates through the MC-EDF 120 and is amplified, and the amplified signal light is output from the core 121d at the end face 122-1 to the core 301d at the end face 302 of the transmission line fiber 300.

As described above, in a case where the transmission direction of the four-core MC-EDF is switched in the optical amplification apparatus, a twist of 180 degrees may be applied to the MC-EDF. Even in such a case, the transmission direction of the MC-EDF can be switched to bidirectional transmission by disposing a mirror and a core for switching the transmission direction in the four-core MC-EDF, in such a way as to have a predetermined positional relationship.

In the first modified example of the third example embodiment, a twist of 90 degrees is applied to the MC-EDF, and in the second modified example of the third example embodiment, a twist of 180 degrees is applied to the MC-EDF, but the angle of the twist is not limited thereto. If a mirror can be placed at the intersection of cores in which the transmission direction change, the angle of twist of the MC-EDF may be any angle. However, with respect to the core arrangement at the time of incidence, the core arrangement at the time of emission is shifted by the angle of the twist. The same applies not only to multi-cores of two cores and four cores but also to multi-cores in which even-numbered cores, such as six cores and eight cores, are arranged concentrically.

### Fourth Example Embodiment

Next, a fourth example embodiment is described. In the present example embodiment, a specific example of an excitation method in the optical amplification apparatus illustrated in the second example embodiment is described. Note that, the excitation method according to the present example embodiment may be applied to the first modified example of the second example embodiment, the third example embodiment, and the first modified example and the second modified example of the third example embodiment.

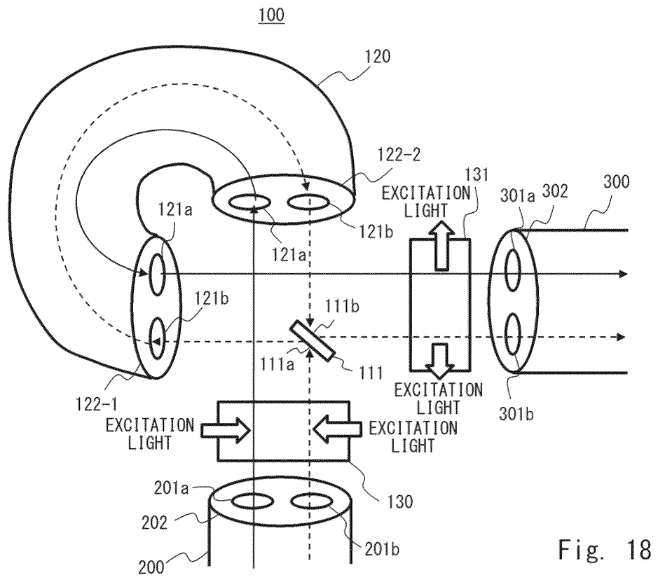

FIG. 18 illustrates a configuration example in which core excitation is performed in an optical amplification apparatus 100 according to some example embodiments. In the example of FIG. 18, in addition to the configuration of FIG. 9, a multiplexing unit 130 and a demultiplexing unit 131 are provided.

The multiplexing unit 130 (coupler) multiplexes signal light and excitation light for each core for core excitation. The multiplexing unit 130 multiplexes, for each core, signal light and excitation light input from a transmission line fiber 200, and inputs the multiplexed light to an MC-EDF 120.

In the example of FIG. 18, the multiplexing unit 130 is disposed between an end face 202 of the transmission line fiber 200, and an end face 122-2 of the MC-EDF 120 and a double-sided mirror 111 (disposed in front of the end face 202 of the transmission line fiber 200). The multiplexing unit 130 multiplexes signal light and excitation light from a core 201a of the transmission line fiber 200, and inputs the multiplexed light to a core 121a at the end face 122-2 of the MC-EDF 120. As a result, the signal light input to the core 121a is excited by the core excitation and amplified.

The multiplexing unit 130 multiplexes signal light and the excitation light from a core 201b of the transmission line fiber 200, and inputs the multiplexed light to a core 121b at an end face 122-1 of the MC-EDF 120 via one face 111a of the double-sided mirror 111. As a result, the signal light input to the core 121b is excited by the core excitation and amplified.

The demultiplexing unit 131 (separator) demultiplexes the optical signal and the excitation light amplified by the core excitation. The demultiplexing unit 131 demultiplexes, for each core, the excitation light from the light output from the MC-EDF 120 and outputs the amplified signal light to a transmission line fiber 300.

In the example of FIG. 18, the demultiplexing unit 131 is disposed between an end face 302 of the transmission line fiber 300, and the end face 122-1 of the MC-EDF 120 and the double-sided mirror 111 (disposed in front of the end face 302 of the transmission line fiber 300). The demultiplexing unit 131 demultiplexes the light output from the core 121a at the end face 122-1 of the MC-EDF 120 into excitation light and signal light, and outputs the demultiplexed signal light to a core 301a of the transmission line fiber 300. As a result, only the signal light amplified by the core 121a of the MC-EDF 120 is propagated.

The demultiplexing unit 131 demultiplexes the light output from the core 121b at the end face 122-1 of the MC-EDF 120 via one side 111b of the double-sided mirror 111 into excitation light and signal light, and outputs the demultiplexed signal light to a core 301b of the transmission line fiber 300. As a result, only the signal light amplified by the core 121b of the MC-EDF 120 is propagated.

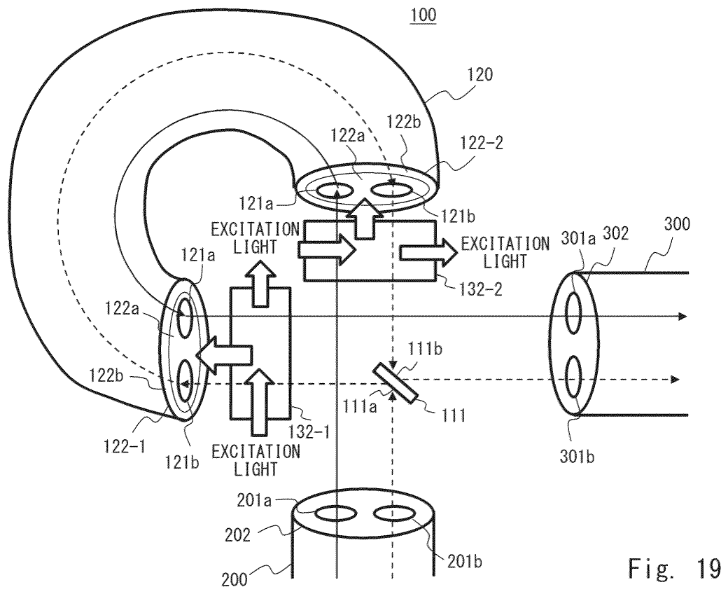

FIG. 19 illustrates a configuration example of a case where cladding excitation is performed in the optical amplification apparatus 100 according to some example embodiments. In such a case, the MC-EDF 120 is a fiber having a double-clad structure including an inner cladding 122a (central-axis-side cladding) and an outer cladding 122b (outer-peripheral-side cladding).

In the example of FIG. 19, in addition to the configuration of FIG. 9, multiplexing/demultiplexing units 132-1 and 132-2 are provided. In order to perform cladding excitation, the multiplexing/demultiplexing units 132-1 and 132-2 (coupler-separators) multiplex the signal light for each core and the excitation light for cladding excitation, and also demultiplex the amplified optical signal and the excitation light by cladding excitation. The multiplexing/demultiplexing units 132-1 and 132-2 perform bidirectional excitation on the MC-EDF 120.

In the example of FIG. 19, the multiplexing/demultiplexing unit 132-1 is disposed between the end face 122-1 of the MC-EDF 120 and the double-sided mirror 111 (in front of the end face 122-1 of the MC-EDF 120). The multiplexing/demultiplexing unit 132-1 multiplexes the signal light and the excitation light input from the core 201b of the transmission line fiber 200 via one side 111a of the double-sided mirror 111, inputs the signal light to the core 121b at the end face 122-1, and inputs the excitation light to an inner cladding 122a at the end face 122-1. As a result, the signal light input to the core 121b is excited and amplified by cladding excitation.

The multiplexing/demultiplexing unit 132-2 is disposed between the end face 122-2 of the MC-EDF 120 and the double-sided mirror 111 (in front of the end face 122-2 of the MC-EDF 120). The multiplexing/demultiplexing unit 132-2 multiplexes the signal light and the excitation light input from the core 201a of the transmission line fiber 200, inputs the signal light to the core 121a at the end face 122-2, and inputs the excitation light to the inner cladding 122a at the end face 122-2. As a result, the signal light input to the core 121a is excited and amplified by cladding excitation.

Further, the multiplexing/demultiplexing unit 132-1 demultiplexes the light output from the core 121a at the end face 122-1 of the MC-EDF 120 and the inner cladding 122a into excitation light and signal light, and outputs the demultiplexed signal light to the core 301a of the transmission line fiber 300. As a result, only the signal light amplified by the core 121a of the MC-EDF 120 is propagated.

The multiplexing/demultiplexing unit 132-2 demultiplexes the light output from the core 121b at the end face 122-2 of the MC-EDF 120 and the inner cladding 122a into excitation light and signal light, and outputs the demultiplexed signal light to the core 301b of the transmission line fiber 300 via the one face 111b of the double-sided mirror 111. As a result, only the signal light amplified by the core 121b of the MC-EDF 120 is propagated.

As described above, in the MC-EDF of the optical amplification apparatus, core excitation may be performed or cladding excitation may be performed. Signal light of each core can be individually excited by core excitation. Signal light of a plurality of cores can be efficiently excited by one beam of excitation light by cladding excitation. For example, in the cladding excitation, by disposing a multiplexing/demultiplexing unit immediately before both end faces of the MC-EDF and performing bidirectional excitation, it is possible to prevent changes in gain and noise figure (NF) due to the transmission direction of signal light.

### Fifth Example Embodiment

Next, a fifth example embodiment is described. In the present example embodiment, an example in which a propagation region of signal light is expanded between an MC-EDF and a transmission line fiber in the optical amplification apparatus illustrated in the second example embodiment is described. Note that, a method for expanding the propagation region of signal light according to the present example embodiment may be applied to the first modified example of the second example embodiment, the third example embodiment, and the first modified example and the second modified example of the third example embodiment.

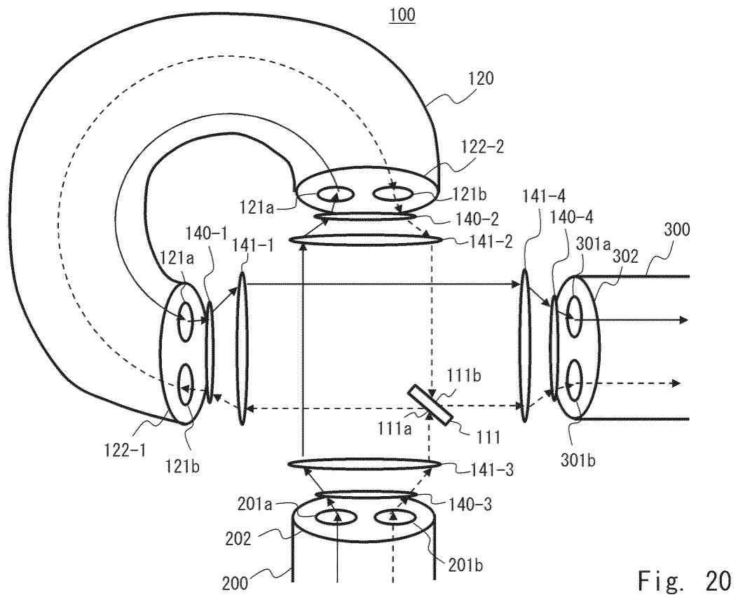

FIG. 20 illustrates a configuration example of an optical amplification apparatus 100 according to some example embodiments. In the example of FIG. 20, in addition to the configuration of FIG. 9, expansion lenses 140-1 to 140-4 and parallel lenses 141-1 to 141-4 are provided. As illustrated in FIG. 20, the expansion lenses 140-1 to 140-4 and the parallel lenses 141-1 to 141-4 are disposed in this order in front of the end faces of each fiber.

The expansion lenses 140-1 to 140-4 expand (in the width direction) the propagation region of signal light output from a fiber. Expanding a propagation region of signal light is to shift the optical axis of signal light (parallel light) in such a way that the distance between signal light being input and output by the plurality of cores is increased. The parallel lenses 141-1 to 141-4 convert the signal light the propagation region of which is expanded by the expansion lenses 140-1 to 140-4 into parallel light (collimated light). The expansion lenses 140-1 to 140-4 and the parallel lenses 141-1 to 141-4 may shift only the optical axis of the signal light being input and output to and from a double-sided mirror 111. Note that, by inputting the signal light to the fiber via the parallel lenses 141-1 to 141-4 and the expansion lenses 140-1 to 140-4, the propagation region of the signal light can be reduced to a size between the cores in the fiber. That is, the expansion lenses 140-1 to 140-4 and the parallel lenses 141-1 to 141-4 are also scaling units that expand and reduce the propagation region of the signal light.

In the example of FIG. 20, the expansion lens 140-1 and the parallel lens 141-1 are disposed in front of an end face 122-1 of an MC-EDF 120. The expansion lens 140-1 emits signal light output from a core 121a at the end face 122-1 toward a direction in which the propagation region expands (a side on which a distance from a core 121b increases). The parallel lens 141-1 emits the signal light output from the core 121a at the end face 122-1 and directed in the direction in which the propagation region is expanded by the expansion lens 140-1 toward the direction in which the signal light becomes parallel light. Specifically, the signal light is emitted to the parallel lens 141-4 on a transmission line fiber 300 side. Thus, the signal light output from the core 121a at the end face 122-1 can be propagated as parallel light the propagation region of which is expanded.

Further, the parallel lens 141-1 emits signal light input from a core 201b of a transmission line fiber 200 via the expansion lens 140-3, the parallel lens 141-3, and one face 111a of the double-sided mirror 111, toward a direction in which the propagation region narrows (a core 121b-side of the end face 122-1). The expansion lens 140-1 emits the signal light input via the one face 111a of the double-sided mirror 111 and directed in a direction in which the propagation region is narrowed by the parallel lens 141-1, toward the core 121b of the end face 122-1. Thus, the signal light from the core 201b of the transmission line fiber 200 and being parallel light the propagation region of which is expanded, can be input to the core 121b at the end face 122-1.

The expansion lens 140-2 and the parallel lens 141-2 are disposed in front of an end face 122-2 of the MC-EDF 120. The expansion lens 140-2 emits signal light output from the core 121b at the end face 122-2, toward a direction in which the propagation region expands (a side on which the distance from the core 121a increases). The parallel lens 141-2 emits the signal light output from the core 121b at the end face 122-2 and directed in the direction in which the propagation region is expanded by the expansion lens 140-2, toward a direction in which the signal light becomes parallel light. Specifically, the signal light is emitted to one side 111b of the double-sided mirror 111. Thus, the signal light output from the core 121b at the end face 122-2 can be propagated as parallel light the propagation region of which is expanded.

Further, the parallel lens 141-2 emits signal light input from a core 201a of the transmission line fiber 200 via the expansion lens 140-3 and the parallel lens 141-3, toward a direction in which the propagation region narrows (a core 121a-side of the end face 122-2). The expansion lens 140-2 emits signal light input via the parallel lens 141-3 and directed in a direction in which the propagation region is narrowed by the parallel lens 141-2, toward the core 121a at the end face 122-2. As a result, the signal light from the core 201a of the transmission line fiber 200, being parallel light the propagation region of which is expanded, can be input to the core 121a at the end face 122-2.

The expansion lens 140-3 and the parallel lens 141-3 are disposed in front of the end face 202 of the transmission line fiber 200. The expansion lens 140-3 emits the signal light output from the core 201a at the end face 202, toward a direction in which the propagation region expands (a side on which the distance from the core 201b increases). The parallel lens 141-3 emits the signal light output from the core 201a at the end face 202 and directed in a direction in which the propagation region is expanded by the expansion lens 140-3, toward a direction in which the signal light becomes parallel light. Specifically, the signal light is output to the parallel lens 141-2 on the end face 122-2-side of the MC-EDF 120. Thus, the signal light output from the core 201a at the end face 202 of the transmission line fiber 200 can be propagated as parallel light the propagation region of which is expanded.

Further, the expansion lens 140-3 emits the signal light output from the core 201b at the end face 202 toward a direction in which the propagation region expands (a side on which the distance from the core 201a increases). The parallel lens 141-3 emits the signal light output from the core 201b at the end face 202 and directed in a direction in which the propagation region is expanded by the expansion lens 140-3, toward a direction in which the signal light becomes parallel light. Specifically, the signal light is output to the one side 111a of the double-sided mirror 111. Thus, the signal light output from the core 201b at the end face 202 of the transmission line fiber 200 can be propagated as parallel light the propagation region of which is expanded.

The expansion lens 140-4 and the parallel lens 141-4 are disposed in front of an end face 302 of the transmission line fiber 300. The parallel lens 141-4 emits the signal light output from the core 121a at the end face 122-1 of the MC-EDF 120 via the expansion lens 140-1 and the parallel lens 141-1, toward a direction in which the propagation region narrows (a core 301b-side of the end face 302). The expansion lens 140-4 emits signal light output via the parallel lens 141-1 and directed in a direction in which the propagation region is narrowed by the parallel lens 141-4, toward a core 301a at the end face 302. Thus, the signal light from the core 121a at the end face 122-1 of the MC-EDF 120, being parallel light the propagation region of which is expanded, can be input to the core 301a at the end face 302 of the transmission line fiber 300.

Further, the parallel lens 141-4 emits the signal light output from the core 121b at the end face 122-2 of the MC-EDF 120 via the expansion lens 140-2, the parallel lens 141-2, and the one side 111b of the double-sided mirror 111, toward a direction in which the propagation region narrows (a core 301a-side of the end face 302). The expansion lens 140-4 emits the signal light output from the one side 111b of the double-sided mirror 111 and directed in a direction in which the propagation region is narrowed by the parallel lens 141-4, toward the core 301b at the end face 302. Thus, the signal light from the core 121b at the end face 122-2 of the MC-EDF 120 via the one side 111b of the double-sided mirror 111, being parallel light the propagation region of which is expanded, can be input to the core 301b at the end face 302 of the transmission line fiber 300.

As described above, in the optical amplification apparatus, an optical component such as a lens may be added in front of each fiber to expand a propagation region of signal light. Thus, the double-sided mirror can be easily disposed. For example, merely collimating the light output from the core requires micron-level processing in order to dispose the double-sided mirror. By shifting in parallel the optical axis of light output from the core by the optical component, it is possible to dispose the double-sided mirror with an accuracy of mm to cm level.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure. Each example embodiment can be combined with other example embodiments as appropriate.

The drawings are merely illustrative of one or more example embodiments.

Each drawing may not be associated with only one particular example embodiment, but may be associated with one or more other example embodiments. As those skilled in the art will appreciate, various features or steps described with reference to any one of the drawings may be combined with features or steps illustrated in one or more other figures, for example, to generate example embodiments not explicitly illustrated or described. All of the features or steps illustrated in any one of the figures to describe the example embodiments are not necessarily essential, and some features or steps may be omitted. The order of the steps described in any of the figures may be changed as appropriate.

Some or all of the above-described example embodiments may be described as the following supplementary notes, but are not limited thereto.

### (Supplementary Note 1)

An optical amplification apparatus being connected between a first multi-core fiber and a second multi-core fiber, including:
a switching unit configured to switch a transmission direction of signal light being unidirectionally transmitted in the first multi-core fiber and the second multi-core fiber, into bidirectional transmission; and
an amplification unit configured to amplify the signal light being bidirectionally transmitted.

### (Supplementary Note 2)

The optical amplification apparatus according to supplementary note 1, wherein
the amplification unit includes a multi-core optical amplification fiber,
the multi-core optical amplification fiber is fixed in such a way that a first end face of the multi-core optical amplification fiber and a second end face of the multi-core optical amplification fiber face each other at a predetermined angle, and
the switching unit includes:
   a first reflection unit configured to reflect signal light being output from a first input-side core of the first multi-core fiber in such a way as to input the reflected signal light into a first amplification core at the first end face of the multi-core optical amplification fiber; and
   a second reflection unit configured to reflect signal light being output from the first amplification core at the second end face of the multi-core optical amplification fiber in such a way as to input the reflected signal light into a first output-side core of the second multi-core fiber.

### (Supplementary Note 3)

The optical amplification apparatus according to supplementary note 2, wherein the first reflection unit and the second reflection unit are disposed at an intersection of a central axis line of the first amplification core at the first end face of the multi-core optical amplification fiber and a central axis line of the first amplification core at the second end face.

### (Supplementary Note 4)

The optical amplification apparatus according to supplementary note 2 or 3, wherein the first reflection unit is a first single-sided mirror, and the second reflection unit is a second single-sided mirror.

### (Supplementary Note 5)

The optical amplification apparatus according to supplementary note 2 or 3, wherein the first reflection unit and the second reflection unit are a double-sided mirror.

### (Supplementary Note 6)

The optical amplification apparatus according to supplementary note 2 or 3, wherein the first end face and the second end face are fixed in such a way as to face each other in a state where one of the first end face and the second end face is rotated at a predetermined angle.

### (Supplementary Note 7)

The optical amplification apparatus according to supplementary note 2 or 3, wherein the switching unit is configured to input signal light being output from a second input-side core of the first multi-core fiber, to a second amplification core at the second end face of the multi-core optical amplification fiber, and input signal light being output from the second amplification core at the first end face of the multi-core optical amplification fiber, to a second output-side core of the second multi-core fiber.

### (Supplementary Note 8)

The optical amplification apparatus according to supplementary note 2 or 3, wherein
the multi-core optical amplification fiber is a multi-core fiber having a double-clad structure, and
the optical amplification apparatus further includes:
   a first multiplexing unit configured to multiplex signal light being input to the first end face of the multi-core optical amplification fiber with excitation light, and input the multiplexed excitation light to a cladding on a central axis side at the first end face; and
a second multiplexing unit configured to multiplex signal light being input to the second end face of the multi-core optical amplification fiber with excitation light, and input the multiplexed excitation light to a cladding on a central axis side at the second end face.

### (Supplementary Note 9)

The optical amplification apparatus according to supplementary note 2 or 3, further including an expansion unit configured to expand a propagation region of signal light being input/output, the expansion unit being disposed between the first end face of the multi-core optical amplification fiber and the first multi-core fiber, and between the second end face of the multi-core optical amplification fiber and the second multi-core fiber.

### (Supplementary Note 10)

An optical transmission system including:
a first multi-core fiber;
a second multi-core fiber; and
an optical amplification apparatus connected between the first multi-core fiber and the second multi-core fiber,
wherein the optical amplification apparatus includes
   a switching unit configured to switch a transmission direction of signal light being unidirectionally transmitted in the first multi-core fiber and the second multi-core fiber, into bidirectional transmission, and
   an amplification unit configured to amplify the signal light being bidirectionally transmitted.

### (Supplementary Note 11)

An optical amplification method for an optical amplification apparatus being connected between a first multi-core fiber and a second multi-core fiber, the method including:
switching a transmission direction of signal light, being unidirectionally transmitted in the first multi-core fiber and the second multi-core fiber, into bidirectional transmission; and
amplifying the signal light being bidirectionally transmitted.

Some or all of the elements (e.g., configurations and functions) described in supplementary notes 2 to 9 depending on supplementary note 1 (optical amplification apparatus) may be dependent on supplementary note 10 (optical transmission system) and supplementary note 11 (optical amplification method) according to the same dependencies as supplementary notes 2 to 9. Some or all of the elements described in any supplementary note may be applied to various hardware, software, recording means for recording software, systems, and methods.

What is claimed is:

1. An optical amplification apparatus being connected between a first multi-core fiber and a second multi-core fiber, comprising:
a switch configured to switch a transmission direction of signal light being unidirectionally transmitted in the first multi-core fiber and the second multi-core fiber, into bidirectional transmission; and
an amplifier configured to amplify the signal light being bidirectionally transmitted.

2. The optical amplification apparatus according to claim 1, wherein
the amplifier includes a multi-core optical amplification fiber,
the multi-core optical amplification fiber is fixed in such a way that a first end face of the multi-core optical amplification fiber and a second end face of the multi-core optical amplification fiber face each other at a predetermined angle, and
the switch includes:
a first reflector configured to reflect signal light being output from a first input-side core of the first multi-core fiber in such a way as to input the reflected signal light into a first amplification core at the first end face of the multi-core optical amplification fiber; and
a second reflector configured to reflect signal light being output from the first amplification core at the second end face of the multi-core optical amplification fiber in such a way as to input the reflected signal light into a first output-side core of the second multi-core fiber.

3. The optical amplification apparatus according to claim 2, wherein the first reflector and the second reflector are disposed at an intersection of a central axis line of the first amplification core at the first end face of the multi-core optical amplification fiber and a central axis line of the first amplification core at the second end face.

4. The optical amplification apparatus according to claim 2, wherein the first reflector is a first single-sided mirror and the second reflector is a second single-sided mirror.

5. The optical amplification apparatus according to claim 2, wherein the first reflector and the second reflector are a double-sided mirror.

6. The optical amplification apparatus according to claim 2, wherein the first end face and the second end face are fixed in such a way as to face each other in a state where one of the first end face and the second end face is rotated at a predetermined angle.

7. The optical amplification apparatus according to claim 2, wherein the switch is configured to input signal light being output from a second input-side core of the first multi-core fiber, to a second amplification core at the second end face of the multi-core optical amplification fiber, and input signal light being output from the second amplification core at the first end face of the multi-core optical amplification fiber, to a second output-side core of the second multi-core fiber.

8. The optical amplification apparatus according to claim 2, wherein
the multi-core optical amplification fiber is a multi-core fiber having a double-clad structure, and
the optical amplification apparatus further comprises:
a first multiplexer configured to multiplex signal light being input to the first end face of the multi-core optical amplification fiber with excitation light, and input the multiplexed excitation light to a cladding on a central axis side at the first end face; and
a second multiplexer configured to multiplex signal light being input to the second end face of the multi-core optical amplification fiber with excitation light, and input the multiplexed excitation light to a cladding on a central axis side at the second end face.

9. The optical amplification apparatus according to claim 2, further comprising an expander configured to expand a propagation region of signal light being input/output, the expander being disposed between the first end face of the multi-core optical amplification fiber and the first multi-core fiber, and between the second end face of the multi-core optical amplification fiber and the second multi-core fiber.

10. An optical transmission system comprising:
a first multi-core fiber;
a second multi-core fiber; and
an optical amplification apparatus connected between the first multi-core fiber and the second multi-core fiber,
wherein the optical amplification apparatus includes
a switch configured to switch a transmission direction of signal light being unidirectionally transmitted in the first multi-core fiber and the second multi-core fiber, into bidirectional transmission, and
an amplifier configured to amplify the signal light being bidirectionally transmitted.

11. The optical transmission system according to claim 10, wherein
the amplifier includes a multi-core optical amplification fiber,
the multi-core optical amplification fiber is fixed in such a way that a first end face of the multi-core optical amplification fiber and a second end face of the multi-core optical amplification fiber face each other at a predetermined angle, and
the switch includes:
a first reflector configured to reflect signal light being output from a first input-side core of the first multi-core fiber in such a way as to input the reflected signal light into a first amplification core at the first end face of the multi-core optical amplification fiber; and
a second reflector configured to reflect signal light being output from the first amplification core at the second end face of the multi-core optical amplification fiber in such a way as to input the reflected signal light into a first output-side core of the second multi-core fiber.

12. An optical amplification method for an optical amplification apparatus being connected between a first multi-core fiber and a second multi-core fiber, the method comprising:
switching a transmission direction of signal light being unidirectionally transmitted in the first multi-core fiber and the second multi-core fiber, into bidirectional transmission; and
amplifying the signal light being bidirectionally transmitted.

13. The optical amplification method according to claim 12, wherein
the amplification is performed in a multi-core optical amplification fiber,
the multi-core optical amplification fiber is fixed in such a way that a first end face of the multi-core optical amplification fiber and a second end face of the multi-core optical amplification fiber face each other at a predetermined angle, and
the switching includes:
reflecting, by a first reflector, signal light being output from a first input-side core of the first multi-core fiber in such a way as to input the reflected signal light into a first amplification core at the first end face of the multi-core optical amplification fiber; and
reflecting, by a second reflector, signal light being output from the first amplification core at the second end face of the multi-core optical amplification fiber in such a way as to input the reflected signal light into a first output-side core of the second multi-core fiber.
